(19) United States
(12) Patent Application Publication
(10) Pub. No.: US 2026/0269862 A1
(43) Pub. Date: Sep. 10, 2026

(54) SPECTRUM WHITENING USING OVERLAPPED FILTERED MULTI-TONE SPREAD SPECTRUM (OFMT-SS) SIGNAL GENERATION AND RECEPTION

(71) Applicant: Battelle Energy Alliance, LLC, Idaho Falls, ID (US)

(72) Inventors: Brian D. Nelson, West Jordan, UT (US); Hussein Moradi, Idaho Falls, ID (US); Behrouz Farhang, Salt Lake City, UT (US)

(21) Appl. No.: 19/556,912

(22) Filed: Mar. 4, 2026

Related U.S. Application Data
(60) Provisional application No. 63/768,535, filed on Mar. 7, 2025.

(51) Int. Cl. H04B 1/709; H04L 27/26

(52) U.S. Cl. CPC H04B 1/709; H04L 27/26025; H04L 27/2623

(57) ABSTRACT

A method of whitening spectrum of filtered multi-tone spread spectrum (FMT-SS) involves generating overlapped FMT-SS (OFMT-SS) signals by inserting additional subcarriers in otherwise unused spectral nulls between adjacent subcarriers in FMT-SS. In some examples, constraints on the additional subcarriers are determined to assure a spectrum of the OFMT-SS signals is substantially flat. In some examples, spreading coefficients of a spreading vector used to spread data symbols across subcarriers of OFMT-SS are limited to binary values of +1 and −1, with adjacent subcarriers of OFMT-SS exhibiting phase differences of π/2. In some examples, the method employs spreading codes optimized using simulated annealing to reduce or minimize a peak-to-average power ratio (PAPR) of the OFMT-SS signals. In some examples, a clipping method to reduce or minimize the PAPR is applied to an extent permitted by a processing gain of OFMT-SS.

### CROSS-REFERENCE TO RELATED APPLICATION

This application claims the benefit under 35 U.S.C. § 119(e) of U.S. Provisional Patent Application Ser. No. 63/768,535, filed Mar. 7, 2025, the disclosure of which is hereby incorporated herein in its entirety by this reference.

### GOVERNMENT RIGHTS

This invention was made with government support under Contract Number DE-AC07-05-ID14517 awarded by the United States Department of Energy. The government has certain rights in the invention.

### TECHNICAL FIELD

Embodiments of the disclosure are directed to the field of wireless transmission of signals and, more particularly, to wireless transmission of spread-spectrum signals.

### BACKGROUND

Spread spectrum (SS) techniques are often used to distribute wireless transmit signals over a wider bandwidth than the minimum required transmission bandwidth. In military applications, SS transmission may be used to avoid jamming and also to reduce the probability of detection or interception. In civilian applications, some forms of SS, known as code-division multiple access (CDMA) may be used to allow multiple users to share the same channel or spectrum. Common techniques being used are direct-sequence spread spectrum (DS-SS) and frequency-hopping spread spectrum (FH-SS). These common SS techniques may suffer from susceptibility to narrow and partial band interference. Multicarrier Spread Spectrum (MC-SS) is a particular form of SS that is designed to be resistant to narrow and/or partial band interference.

Use of a filter bank multicarrier (FBMC) technique for spread spectrum communications has been reported in a number of publications. All of these works make use of filtered multi-tone (FMT) for signal synthesis, and thus, may be referred to as FMT-SS. As compared to the more conventional spread spectrum techniques, such as DS-SS and FH-SS methods, FMT-SS is shown to be more robust to partial-band interferers, as filter bank structure allows straightforward removal of interferences at a cost of reduced processing gain.

Although FMT-SS has the above advantages when compared to conventional spread spectrum techniques, it is known to suffer from a non-flat power spectral density (PSD) which follows since subcarrier bands, by design, are non-overlapping. This leaves a spectral null between each pair of adjacent subcarrier bands, i.e., a portion of the transmission band without any transmission power.

FIG. 1A is a plot 100A illustrating a non-flat PSD curve 102 of subcarriers in an FMT-SS signal of a conventional system. For a given transmit power, the presence of spectral nulls 104 in PSD curve 102 increases the peak or peaks of the PSD, which results in increased interference to other communications over the active subcarrier bands. In addition, the presence of spectral nulls 104 could reveal a transmitter's identity and parameters to an unauthorized observer that wishes to detect the transmitted information and/or to intercept the communication.

To remove the FMT-SS spectral profile, an alternative approach that results in a flat spectrum can be employed. In this alternative approach, FMT is replaced by staggered multi-tone (SMT) modulation. SMT uses offset quadrature amplitude modulation (OQAM) for overlapping of adjacent subcarrier bands, and hence, leads to a near flat PSD of the synthesized signal. However, this alternative approach uses an FMT-SS preamble to perform synchronization and channel estimation, thus maintaining the undesirable spectral profile for a portion of the transmission.

### BRIEF DESCRIPTION OF THE DRAWINGS

FIG. 1A is a plot illustrating a non-flat power spectral density (PSD) curve of subcarriers in a filtered multi-tone (FMT) spread spectrum (SS) (FMT-SS) signal of a conventional system;

FIG. 1B is a plot illustrating a PSD curve of subcarriers in an overlapped FMT-SS (OFMT-SS) signal, according to one or more examples;

FIG. 2 is a plot of η(t) in FMT-SS of the conventional system;

FIG. 3 is a plot of α(t) in OFMT-SS, according to one or more examples;

FIG. 4 is a graph of magnitude responses of respective clipping removal pulses of different orders K, according to one or more examples;

FIG. 5 is a plot of grouped histograms of cross-correlations associated with choices of multi-codes of different lengths L;

FIG. 6 is a plot of complementary cumulative distribution function (CCDF) curves of the instantaneous power of the synthesized signal normalized by its average power, according to one or more examples;

FIG. 7 is a plot of PSD results before and after applying a clipping algorithm and a peak-to-average power ratio (PAPR) reduction algorithm, according to one or more examples;

FIG. 8 is a plot of PSD results before and after applying the PAPR reduction algorithm for different clipping pulse orders K, according to one or more examples;

FIG. 9 is a plot of PSD results after applying the PAPR reduction algorithm for different iterations P and clipping thresholds p, according to one or more examples;

FIG. 10 is a plot of a simulated bit error rate (BER) curve of single-code OFMT-SS, according to one or more examples, and also includes a theoretical Quadrature Phase Shift Keying (QPSK) BER curve for comparison;

FIG. 11 is a plot of simulated symbol error rate (SER) curves of multi-code OFMT-SS, according to one or more examples, and also includes theoretical curves for comparison;

FIG. 12 is a plot of simulated SER curves for several PAPR reduction thresholds p, according to one or more examples;

FIG. 13 is a plot of simulated SER curves for single-code and multi-code OFMT-SS over long-term evolution (LTE) Extended Vehicular A (EVA) channels, as compared to theoretical additive white Gaussian noise (AWGN) curves, according to one or more examples;

FIG. 14 is a schematic diagram of an OFMT-SS transmitter with single-code (SC) spreading, according to one or more examples;

FIG. 15 is a schematic diagram of an OFMT-SS baseband modulator with single-code spreading from FIG. 14, according to one or more examples;

FIG. 16 is a flowchart of a method of OFMT-SS transmitter processing with single-code spreading, according to one or more examples;

FIG. 17 is a schematic diagram of an OFMT-SS transmitter with multi-code (MC) spreading, according to one or more examples;

FIG. 18 is a schematic diagram of an OFMT-SS baseband modulator with multi-code spreading from FIG. 17, according to one or more examples;

FIG. 19 is a flowchart of a method of OFMT-SS transmitter processing with multi-code spreading, according to one or more examples;

FIG. 20 is a schematic diagram of an OFMT-SS receiver with single-code despreading, according to one or more examples;

FIG. 21 is a schematic diagram of a symbol despreader for multi-code despreading for FIG. 20, according to one or more examples;

FIG. 22 is a flowchart of a method of OFMT-SS receiver processing with single-code despreading, according to one or more examples;

FIG. 23 is a flowchart of a method of OFMT-SS receiver processing with multi-code despreading, according to one or more examples; and

FIG. 24 is a block diagram of circuitry that, in some examples, may be used to implement various functions, operations, acts, processes, and/or methods disclosed herein.

### DETAILED DESCRIPTION

In the following description, reference is made to the accompanying drawings in which is shown, by way of illustration, specific embodiments in which the disclosure may be practiced. The embodiments are intended to describe aspects of the disclosure in sufficient detail to enable those skilled in the art to make, use, and otherwise practice the invention. Furthermore, specific implementations shown and described are only examples and should not be construed as the only way to implement the disclosure unless specified otherwise herein. It will be readily apparent to one of ordinary skill in the art that the various embodiments of the disclosure may be practiced by numerous other partitioning solutions. Other embodiments may be utilized and changes may be made to the disclosed embodiments without departing from the scope of the disclosure. The following detailed description is not to be taken in a limiting sense, and the scope of the present invention is defined only by the appended claims.

In the following description, elements, circuits, and functions may be shown in block diagram form in order not to obscure the disclosure in unnecessary detail. Conversely, specific implementations shown and described are exemplary only and should not be construed as the only way to implement the disclosure unless specified otherwise herein. Additionally, block definitions and partitioning of logic between various blocks is exemplary of a specific implementation. It will be readily apparent to one of ordinary skill in the art that the disclosure may be practiced by numerous other partitioning solutions. For the most part, details concerning timing considerations and the like have been omitted where such details are not necessary to obtain a complete understanding of the disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, e.g., a combination of a DSP and a microprocessor, a plurality of microprocessors, one or more microprocessors in conjunction with a DSP core, or any other such configuration.

Also, it is noted that embodiments may be described in terms of a process that may be depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

According to the disclosure, a new form of filter bank multicarrier spread spectrum (FBMC-SS) waveform is provided. The waveform modifies a filtered multi-tone spread spectrum (FMT-SS) system and is directed to whitening a power spectral density (PSD) of an FMT-SS transmit signal. In conventional FMT-SS, subcarrier bands are non-overlapping, resulting in spectral nulls between adjacent subcarrier bands. In one or more examples of the disclosure, additional subcarriers are positioned and centered at these nulls, thereby forming a modified version of FMT-SS, referred to herein as overlapped FMT-SS (OFMT-SS).

Thus, a method for whitening spectrum of FMT-SS is disclosed. The method includes generating OFMT-SS signals by inserting or positioning additional subcarriers in otherwise unused spectral nulls between adjacent subcarriers of FMT-SS. One or more features of the disclosure allow subcarrier band spacings in OFMT-SS at integer multiples of a symbol rate rather than twice the symbol rate.

In one or more examples, the method further includes determining constraints on the additional subcarriers to assure a spectrum of the OFMT-SS signals is substantially flat (e.g., for a perfectly flat PSD).

In one or more examples, the method further includes limiting spreading coefficients of a spreading vector used to spread data symbols across subcarriers of OFMT-SS to binary values of +1 and −1, with adjacent subcarriers of OFMT-SS exhibiting phase differences of π/2 (90 degrees).

In one or more examples, the OFMT-SS signals are generated using either a single spreading code for information spreading (e.g., single-code spreading) or a set of spreading codes for increasing a data rate of communications (e.g., multi-code spreading). In one or more examples, the method is based on a performance-optimized selection of spreading gains in single-coded and multi-coded designs.

In one or more examples, the method employs spreading codes optimized using simulated annealing to reduce or minimize a PAPR of the OFMT-SS signals.

In one or more examples, the method employs spreading codes generated by circularly shifting a seed code (e.g., enabling a low-complexity decoder design) to reduce or minimize the PAPR of the OFMT-SS signals.

In one or more examples, the method further includes applying a clipping method to reduce or minimize the PAPR to an extent permitted by a processing gain of OFMT-SS.

In the disclosure, various performance impacts and design conditions for OFMT-SS are examined. The impact of the added subcarriers on system performance is assessed. Conditions for maximally flattening the PSD of the synthesized OFMT-SS signal and for canceling interference caused by overlapping subbands are analyzed. Spreading gains that provide a low peak-to-average power ratio (PAPR) under various scenarios are considered and discussed. Additional reduction of the PAPR of the synthesized signal through clipping techniques is also assessed.

According to the disclosure, an alternative FBMC-SS approach having a substantially flat PSD that can be used for both preamble and payload portions of a packet is described. This approach modifies FMT-SS by inserting additional subcarriers over the null bands with the goal of flattening the PSD of the synthesized signal. The modified waveform is referred to as overlapped FMT-SS or OFMT-SS.

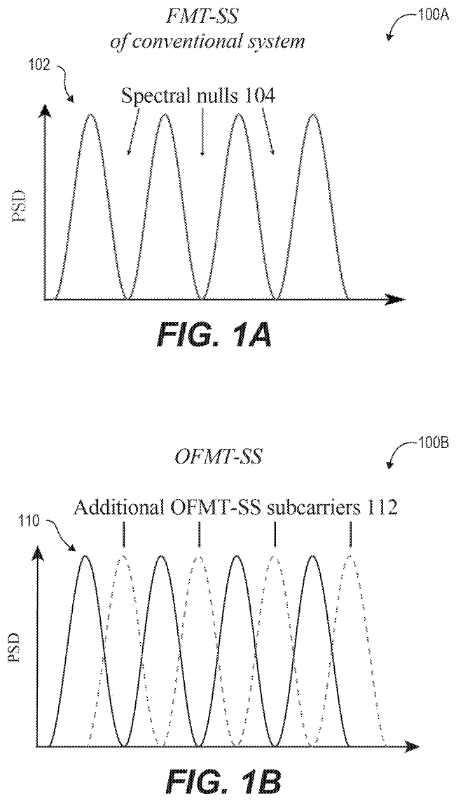

FIG. 1B is a plot 100B of a PSD curve 110 of subcarriers in an OFMT-SS signal, according to one or more examples. In PSD curve 110, additional subcarriers 112 are inserted into the null bands between existing subcarriers (e.g., compare with FIG. 1A), thereby eliminating the pre-existing nulls from the spectral profile.

Although the subcarrier overlap improves spectral efficiency, it may also introduce inter-carrier interference (ICI) and fluctuations in the PSD. In one or more examples of the disclosure, design methods are applied to minimize ICI and reduce PSD fluctuations caused by subcarrier overlap. In one or more additional examples of the disclosure, design approaches are introduced to maintain the PAPR of the synthesized signal at a reduced level while increasing the data rate through a multi-coding method.

In one or more examples, the disclosure provides the following:
1) An OFMT-SS waveform is disclosed as an effective multicarrier spread spectrum method;
2) A pulse-shape design that removes ICI among adjacent subcarriers and leads to a flat, or perfectly flat, spectrum in the transmit signal is disclosed;
3) A multi-code method that enables variable data rate OFMT-SS transmissions is disclosed. Making use of simulated annealing, a code design method that results in a relatively low PAPR, is also disclosed; and
4) Methods that limit the PAPR of OFMT-SS signals, which are shown to be very effective in the application, are disclosed. It is shown that the PAPR of OFMT-SS can be reduced to as low as 4 dB (or, even lower), with a negligible error rate performance loss, due to the spread spectrum nature of the OFMT-SS signal.

In this scenario, by flattening the power spectral density (PSD) of the transmit signal across the transmission band, OFMT-SS can transmit approximately twice the power compared to FMT-SS, resulting in increased transmission range. This improvement may provide significant advantages in applications in which FMT-SS has previously been employed.

OFMT-SS has advantages over FMT-SS in applications including, but not limited to, underlay communications, skywave high frequency (HF), and ultra-wideband (UWB) waveforms. FMT-SS has been suggested as an underlay communication channel to exchange spectral information among the nodes in a cognitive radio network. To minimize interference to other radios that may be using the same spectrum, it may be advantageous to use OFMT-SS to keep the PSD of the synthesized signal as low as possible. FMT-SS application for communications over skywave HF channels (e.g., in the 3 MHz to 30 MHz spectrum) has been explored in the past. In this domain, spectral allocations are nearly uncontrolled and therefore interference amongst different users of the HF spectrum is likely. Keeping the PSD of the transmitted signals in OFMT-SS substantially flat, and hence, minimizing the peak of the PSD, is of great value here as well. UWB waveforms have been proposed for short range communications over the spectral bands that have been licensed for variety of applications. In order to avoid interference with the licensed users of these spectral bands, the Federal Communications Commission (FCC) has mandated that the PSD of any UWB waveform should remain below a spectral mask at the transmitter antenna output. The use of filter banks for UWB communications have been recently proposed. Making use of OFMT-SS may double the transmission power compared to its FMT-SS counterpart, hence, may significantly improve on the transmission range.

The rest of the disclosure is organized as follows. Section I is a discussion of FMT-SS. Here, the basic results of FMT-SS that are relevant to the remaining parts of the disclosure are summarized. Section II introduces the OFMT-SS waveform and explores how its pulse shape can be constrained/designed to remove ICI and (e.g., perfectly) flatten the PSD of the transmit signal. Section III presents a strategy for designing the OFMT-SS pulse shape to minimize PAPR while the constraints outlined in Section II are imposed. A design of multi-codes for increasing data rate, while minimizing PAPR is also presented. In Section IV, the application of clipping methods to further reduce the PAPR of OFMT-SS is disclosed. The proposed pulse-shape design and clipping method are evaluated through numerical examples in Section V. The observations are further confirmed through bit-error rate (BER) and symbol-error rate (SER) in Section VI.

### I. Filtered Multi-Tone Spread-Spectrum (FMT-SS)

FMT-SS is a signaling scheme in which multiple frequency tones are simultaneously transmitted and shaped by filtering to spread energy over a defined bandwidth, enabling robust signal separation and interference mitigation in sensing or communication systems. The FMT-SS scheme is described in U.S. Pat. No. 8,861,571 B2, issued Oct. 14, 2014, which is hereby incorporated by reference herein in its entirety.

In FMT-SS, spreading chips are across a set of non-overlapping subcarrier bands. Accordingly, the transmit pulse shape/filter is given as

$$g ( t ) = {\sum }_{k = 0}^{N - 1} {γ}_{k} h ( t ) {e}^{{j 2 π f}_{k} t} \qquad ( 1 )$$

where N is the number of subcarriers, the coefficients γₖ are a set of complex-valued and unit-amplitude spreading gains, h(t) is the prototype filter, and fₖ is the center frequency of the k^{th} subcarrier band.

It has been shown that the combined impulse response of the transmit and receive filters, i.e., η/(t)=g(t)*g*(—t), can be factored as

$$η ( t ) = β ( t ) ρ ( t ) \qquad ( 2 )$$

$$where$$

$$ρ ( t ) = h ( t ) * {h}^{*} ( - t ) \qquad ( 3 )$$

$$and$$

$$β ( t ) = {\sum }_{k = 0}^{N - 1} {e}^{{j 2 π f}_{k} t} \qquad ( 4 )$$

Moreover, by design, h(t) is a real-valued and symmetric square-root Nyquist filter. Accordingly, ρ(t) is a real valued and symmetric Nyquist filter.

In the FMT-SS design, the subcarriers are spaced at 2/T Hz apart, where T is the symbol interval. This allows a prototype filter design with maximum transition bandwidth, thus minimizing the cost of implementing the underlying filter bank by allowing a lower order filter for the same stopband attenuation. In addition, the subcarrier frequencies, at the baseband, are chosen to be

$${f}_{k} = \frac{2 ( k - N / 2 ) + 1}{T} , \qquad ( 5 )$$

$$for$$

$$k = 0 , 1 , … , N - 1.$$

It is also shown that with these choices, the combined impulse response η(t) consists of three ‘sinc’ pulses at the time positions t=−T/2, 0, and T/2.

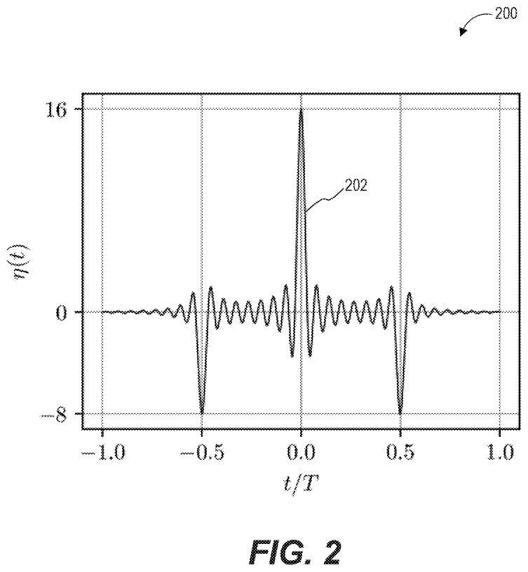

FIG. 2 is a plot 200 of a combined impulse response η(t) 202 in FMT-SS (e.g., where N=16) of the conventional system. Using the preamble structure of the FMT-SS scheme, the pulses of η(t) may be used for carrier acquisition and timing recovery at the receiver.

In certain applications, it is exceedingly important to design FMT-SS waveform to synthesize signals with a minimum peak-to-average power ratio (PAPR). A particular case that FMT-SS has been applied to and requires a low PAPR is communication over skywave HF channels, where transmit power can be many tens or, even, many hundreds of watts. Hence, power efficiency of the transmitter power amplifier becomes a key design factor. PAPR minimization of FMT-SS has been explored in previous work. To this end, it has first been noted that (1) can be rearranged as

$$g ( t ) = h ( t ) m ( t ) \qquad ( 6 )$$

$$where$$

$$m ( t ) = {\sum }_{k = 0}^{N - 1} {γ}_{k} h ( t ) {e}^{{j 2 π f}_{k} t} . \qquad ( 7 )$$

Next, it has been argued that to avoid large peaks in the synthesized signal (equivalently, to minimize the PAPR), the spreading gain factors γₖ have to be chosen such that the crest-factor of m(t) is minimized. The crest-factor of a signal is defined as its maximum amplitude over its root-mean-square (RMS) value. Friese has proposed an algorithm (or “Friese optimization method”) for minimizing the crest-factor of m(t). This algorithm leads to the choices of γₖ that results in a crest-factor of as low as 1.07 and for the synthesized FMT-SS signal a PAPR of as low as 3.61 dB.

Even though the emphasis above and the study of reducing PAPR of FMT-SS was motivated by its specific application to HF communications, PAPR minimization is of interest in all applications. By minimizing the PAPR, transmitter power amplifiers can operate more efficiently and device power consumption can be reduced. Given this point, a significant part of the disclosure is allocated to PAPR reduction in OFMT-SS; see Sections III and IV.

### II. Overlapped FMT-SS (OFMT-SS)

While in FMT-SS the subcarrier center frequencies, at the baseband, may be expressed as in (5), for OFMT-SS they are chosen as

$${\overline{f}}_{k} = \frac{k - N + \frac{1}{2}}{T} , \qquad ( 8 )$$

$$for$$

$$k = 0 , 1 , … , L - 1$$

$$where$$

$$L = 2 N . \qquad ( 9 )$$

Note that if the symbol rate is kept the same in FMT-SS and OFMT-SS, the above choices of f̅ₖ̅ minimally affect the transmission bandwidth of OFMT-SS when compared to its FMT-SS counterpart. Also, to keep the equations distinguishable between FMT-SS and OFMT-SS, one can add an over-bar for the variables/functions that are related to OFMT-SS and are different from their counterpart in FMT-SS. Hence, the OFMT-SS pulse-shaping filter is expressed as

$$\overline{g} ( t ) = {\sum }_{k = 0}^{L - 1} {\overline{γ}}_{k} h ( t ) {e}^{j 2 π {\overline{f}}_{k} t} . \qquad ( l0 )$$

Note that both g(t) and g̅(t) are based on the same prototype filter h(t). However, as noted above, to keep the transmission bandwidth the same, the number of subcarrier bands are doubled. Reducing the spacing between subcarriers leads to some differences in the system impulse response.

Here, the combined response of g̅(t) and its matched version leads to the system impulse response

$$\overline{η} ( t ) = \overline{g} ( t ) * {\overline{g}}^{*} ( ⋯ t ) = ( {\sum }_{k = 0}^{L - 1} {\overline{γ}}_{k} h ( t ) {e}^{j 2 π {\overline{f}}_{k} t} ) * ( {\sum }_{k = 0}^{L - 1} {\overline{γ}}_{k}^{*} h ( t ) {e}^{j 2 π {\overline{f}}_{k} t} ) . \qquad ( 11 )$$

Taking note that only aligned and adjacent subcarrier bands overlap, (11) can be rearranged to

$$\overline{η} ( t ) = a ( t ) + c ( t ) \qquad ( 12 )$$

$$where$$

$$a ( t ) = {\sum }_{k = 0}^{L - 1} {\overline{γ}}_{k} h ( t ) {e}^{j 2 π {\overline{f}}_{k} t} * {\sum }_{k = 0}^{L - 1} {\overline{γ}}_{k}^{*} h ( t ) {e}^{j 2 π {\overline{f}}_{k} t} \qquad ( 13 )$$

accounts for the aligned terms, and

$$e ( t ) = {\sum }_{k = 0}^{L - 2} {\overline{γ}}_{k} h ( t ) {e}^{j 2 π {\overline{f}}_{k} t} * {\overline{γ}}_{k + 1}^{*} h ( t ) {e}^{j 2 π {\overline{f}}_{k + 1} t} + {\sum }_{k = 0}^{L - 2} {\overline{γ}}_{k}^{*} h ( t ) {e}^{j 2 π {\overline{f}}_{k} t} * {\overline{γ}}_{k + 1} h ( t ) {e}^{j 2 π {\overline{f}}_{k + 1} t} \qquad ( 14 )$$

accounts for the crossed terms between the adjacent subcarrier bands. The remaining terms are ignored, as in a well-designed prototype filter they have a negligible contribution to the result of (11). By factoring the impulse response into these two sets of terms, one can gain insight into how the reduced subcarrier spacing impacts the shape of the PSD and the ICI. Separate analyses of α(t) and c(t) are presented below.

### A. Aligned Terms

Straightforward manipulations lead to

$$a ( t ) = \overline{β} ( t ) ρ ( t ) \qquad ( 15 )$$

$$where$$

$$\overline{β} ( t ) = {\sum }_{k = 0}^{L - 1} {e}^{j 2 π {\overline{f}}_{k} t} \qquad ( 16 )$$

ρ(t) is given by (3), and f̅ₖ is given by (8). Here, note that β(t) has a similar form to β(t) defined in equation (4), but with a frequency spacing of 1/T Hz between the sinusoidal terms instead of 2/T Hz. By using 1/T Hz as the frequency spacing of the sinusoids in (16), (β̅(t) is a sinc pulse train with a spacing of T between peaks. This leads us to conclude that α(t) is similar to η/(t) shown in FIG. 2, but with the sine pulses at time instants ±T/2 removed and the height of the sine pulse at t=0 doubled.

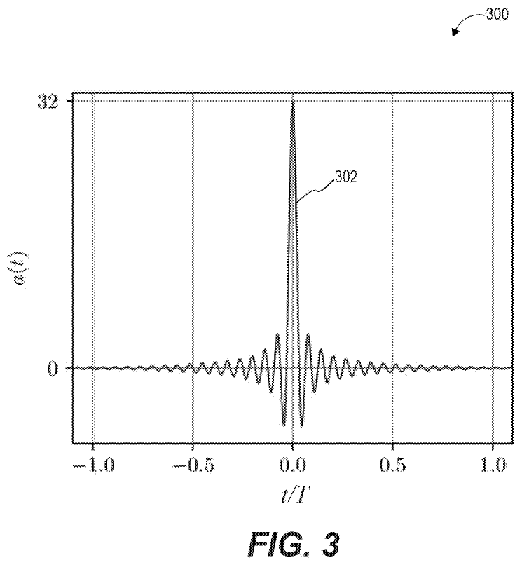

FIG. 3 is a plot 300 of a combined impulse response α(t) 302 in OFMT-SS (e.g., where L=15), according to one or more examples.

The above results show that α(t) is a Nyquist pulse with regular zero crossings at the interval T/L. This implies that, if one could force c(t) to zero, the pulse-shape g̅(t) would be a square-root Nyquist pulse with a bandwidth of L/T, leading to a flat spectrum across the band of transmission. An alternative way of looking at this result is to first recall that h(t) is chosen so that ρ(t) is a Nyquist pulse with bandwidth 1/T and roll-off factor α. Second, since α(t) is the sum of L copies of ρ(t) modulated to integer multiples of 1/T, α(t) is a Nyquist pulse with bandwidth L/T and roll-off factor α/L. Next, the constraints that need to be imposed to force c(t) to zero are discussed.

### B. Cross Terms

To analyze c(t), one can start by defining

$$d ( t ) = h ( t ) * h ( t ) {e}^{j \frac{2 π}{T} t} . \qquad ( 17 )$$

After applying some straightforward manipulations to (14), and making use of (17), one finds that

$$c ( t ) = d ( t ) {\sum }_{k = 0}^{L - 2} {e}^{j 2 π {\overline{f}}_{k} t} ( {\overline{γ}}_{k}^{*} {\overline{γ}}_{k + 1} + {\overline{γ}}_{k} {\overline{γ}}_{k + 1}^{*} ) \qquad ( 18 )$$

One can choose the spreading gains γ̅ₖ̅ so that

$$c ( t ) = 0 \qquad ( 19 )$$

By solving this equation, it can be guaranteed that η̅(t)=α(t), hence, the OFMT-SS signal will have flat spectrum, i.e., a white PSD across the band of transmission.

For (19) to be satisfied, the spreading gains should be chosen so that

$${\overline{γ}}_{k}^{*} {\overline{γ}}_{k + 1} + {\overline{γ}}_{k} {\overline{γ}}_{k + 1}^{*} \qquad ( 20 )$$

$$for$$

$$k = 0 , 1 , … , L - 2.$$

Defining the spreading gain vector as

$$\overline{γ} = [ \begin{matrix}{\overline{γ}}_{0} & {\overline{γ}}_{1} & ⋯ & {\overline{γ}}_{L - 1}\end{matrix} ] \qquad ( 21 )$$

it can be shown that the only spreading sequences that satisfy (20) have the form:

$$\overline{γ} = {e}^{j ϕ} b ⊙ ζ$$

$$where$$

$$b = {[ \begin{matrix}1 & j & {j}^{2} & ⋯ & {j}^{L - 1}\end{matrix} ]}^{T} . \qquad ( 22 )$$

⊙ denotes an element-wise product, φ is an arbitrary phase, and (23)

$${ζ}_{k} ∈ \{ - 1 , + 1 \} , \qquad ( 24 )$$

$$for$$

$$0 \leq k \leq L - 1.$$

The result in (22) can be proved by letting γ̅ₖ̅=e^{jφk} and γ̅ₖ̅₊̅₁̅=e^{jφk+1} in (21) and noting that this leads to

$$cos ( {ϕ}_{k + 1} - {ϕ}_{k} ) = 0. \qquad ( 25 )$$

This result implies

$${ϕ}_{k + 1} - {ϕ}_{k} = n π \pm \frac{π}{2} . \qquad ( 26 )$$

Letting γ̅₀̅=±e^{jφ} and making use of (26), one can see that (22) holds.

In the rest of this disclosure, for simplicity, and without any loss of generality of the optimization methods that will be introduced, we let γ̅₀̅=1.

### III. OFMT-SS PAPR Minimization

PAPR minimization is desirable in all communication systems. Here, a design strategy is presented that allows selection of the elements of the vector (with the goal of minimizing the PAPR of the synthesized OFMT-SS signal. In previous work on FMT-SS, it was found that PAPR minimization of such signals is closely related to minimization of the crest-factor of the multi-tone signal m(t) in (7). The same is true here, with the difference that the spreading coefficients γ̅ₖ̅ are constrained to the discrete choices expressed by (22). In FMT-SS the spreading coefficients γₖ can choose any unit amplitude complex value. This allows the use of the Friese optimization method for minimizing the crest-factor of m(t).

Unfortunately, there is no similar method to Friese optimization that works well when the spreading coefficients are allowed to select values from a finite/discrete set. Although an approach for finding discrete spreading gain coefficients resulting in a moderate crest-factor of approximately 2 has been previously suggested, it is recognized that these coefficients are likely not optimal. It turns out that the only way of finding the set of γ̅ₖ̅ that minimizes the crest-factor of

$$\overline{m} ( t ) = {\sum }_{k = 0}^{L - 1} {\overline{γ}}_{k} {e}^{j 2 π {\overline{f}}_{k} t} \qquad ( 27 )$$

is to search over all 2^{L} choices of the vector ζ. This clearly has a complexity that grows exponentially with L and, thus, is not scalable as L grows. Common methods of solving this type of problem make use of statistical search approaches, such as Markov chain Monte Carlo (MCMC), genetic, or simulated annealing algorithms.

According to one or more examples, a simulated annealing (SA) algorithm is chosen for the spreading code design. Simulated annealing is a stochastic optimization algorithm where a cost function is minimized in a manner similar to how the molecules in materials cool to lower energy states. The simulated annealing algorithm of the disclosure may be based on an earlier SA approach, and in particular, H. DENG, “Synthesis of binary sequences with good autocorrelation and crosscorrelation properties by simulated annealing,” IEEE transactions on aerospace and electronic systems, vol. 32, no. 1, pp. 98-107, 1996, which is hereby incorporated by reference herein in its entirety.

In the simulated annealing algorithm, an initial state is chosen at random and used to evaluate the cost function. At each iteration of the algorithm, the state is perturbed, and the cost of the new state is measured. If the cost is reduced, the perturbed state is accepted. If the cost increases, then the new state is accepted with some probability that depends on the increase in cost and on the “temperature” of the algorithm. This process of perturbation and state updates is repeated until an “equilibrium” is reached. One can use the definition of equilibrium that relates to the standard deviation of the cost at the current temperature to detect equilibrium. When the algorithm converges to an equilibrium state, the temperature is lowered and the algorithm is continued at the new temperature. Lowering the temperature reduces the probability of accepting a state that increases the cost. The algorithm exits once the cost of the state vector has not changed for several steps of the temperature. By gradually reducing the temperature, the algorithm converges to a global optimum. Simulated annealing has been discussed in many publications, and in particular, for optimization over a discrete space.

The author of the earlier SA approach used simulated annealing to design binary sequences with good aperiodic autocorrelation and cross correlation properties. The good autocorrelation is quantified by the relative size of the autocorrelation coefficients for non-zero lags when compared to the signal power (i.e., autocorrelation with a zero lag). The sequences with smaller non-zero lag autocorrelation coefficients are considered as better sequences. It turns out that sequences with small non-zero lag autocorrelation coefficients result in a lower crest-factor when such sequences are used to construct a multi-tone signal like m̅(t). Accordingly, the simulated annealing algorithm of the disclosure can be designed by modifying the earlier SA approach, as the optimization space and criterion discussed in the earlier approach are related to the present approach.

The first modification that is made to the earlier SA approach is to increase the number of reachable vectors in the state update step of the algorithm. This is done by flipping the sign of up to W spreading gains in a single iteration instead of flipping just one, as is done in the earlier SA approach. At each iteration, the number of spreading gains to change is chosen from a uniform distribution, X~U(1, W). Then, X randomly selected spreading gains are changed to update the state vector. It is found that a modest increase of W from 1 to 2 leads to a lower cost function, and hence, a better design.

The second modification that is made is the use of different cost functions than the aperiodic autocorrelation used in the earlier SA approach. Through experimental studies, it has been realized that the choice of a good cost function depends on the system implementation. Here, two implementations of OFMT-SS system are of interest. The first implementation emphasizes on keeping the transmit power at a minimum value. For this case, a single spreading code should be used, allowing transmission of a single bit (using a binary phase shift keying (BPSK) data symbol) or a pair of bits (using a quadrature phase shift keying (QPSK) data symbol) per code interval. Alternatively, one may choose to use a choice of spreading gain vector γ̅ₖ̅ from a set of M multi-codes for transmission over each code interval. This, as discussed below, allows transmission of more information bits per code interval. These two implementations and the relevant cost functions/code designs are discussed in the sequel.

TABLE I
AN EXAMPLE OF PAPR RESULTS,
COMPARING OFMT-SS WITH FMT-SS

| Spreading Gain Set | Crest Factor | PAPR (dB) |
|---|---|---|
| FMT-SS | 1.07 | 3.61 |
| OFMT-SS | 1.43 | 5.07 |

### A. Design for Single Codes

When designing a spreading coefficient vector for use with a single transmission code, the crest-factor is chosen as the cost function for the simulated annealing algorithm. It was found that directly minimizing the crest-factor leads to a lower PAPR than what would be obtained using the aperiodic autocorrelation cost function proposed in the earlier SA approach. The PAPR performance of the codes generated with this method are summarized in Table I, and compared with the PAPR performance of an FMT-SS operating with improved or optimized spreading gains according to previous design methods. For the cases presented here, the number of subcarriers in FMT-SS is set to N=64, and for OFMT-SS, L=2N=128. As shown, despite the constraints on the permissible choices of the coefficients γ̅ₖ̅, the PAPR loss remains relatively low; only 5.07-3.61=1.46 dB. It is also shown that the simulated annealing approach generates spreading gain sets with a crest-factor significantly lower than 2. It is also worth noting that the improved or optimized spreading gain set of FMT-SS results in a significantly better result than those reported with respect to the previous design methods. This is the best result that was obtained after initializing and running the Friese optimization method many times.

### B. Design for Multi-Codes

Application of multi-codes to FMT-SS has been described in previous work. Here, a trivial method of finding a set of orthogonal codes that minimally affect the PAPR of the improved or optimized design for a single code was proposed. In this work, biorthogonal signaling was used to increase the data rate—i.e., spreading gain vectors were selected from a set of vectors Γ={±γ₀, ±γ₁, . . . ,±γ_{M-1}} where γᵢ^{T}γⱼ=0 for i≠j. Because positive and negative versions of each spreading gain vector are included in Γ, it has a cardinality of 2M vectors, and, thus, B=log₂(M)+1 bits are transmitted per code interval, if all the codes are deployed. Noting that the number of code vectors can be as large as the code length, OFMT-SS allows doubling the number of code vectors when compared to FMT-SS.

For FMT-SS, a set of orthogonal multi-code vectors can be generated from an improved or optimized spreading gain vector γ₀ by point-wise multiplying γ₀ by the columns of the DFT matrix of the same size. In this case each multi-code vector has the same crest-factor as the original improved or optimized vector. Point-wise multiplying by the columns of the DFT matrix modulates the spreading gain vector with complex sinusoids of different frequencies, which is a linear phase shift of the coefficients. The crest-factor remains unchanged because the spreading gain coefficients are the discrete Fourier series (DFS) coefficients of the time domain signal m(t) and applying a linear phase shift to the coefficients results in a time shift of m(t). This does not change the crest-factor of m(t), hence, has little effect on the PAPR.

TABLE II
PAPR RESULTS OF MULTI-CODE SIGNALS FOR
HADAMARD-BASED AND AUTOCORRELATION-
BASED DESIGNS

| | B | | | | | | | |
|---|---|---|---|---|---|---|---|---|
| | 1 | 2 | 3 | 4 | 5 | 6 | 7 | 8 |
| Hada- | 5.07 | 5.08 | 8.31 | 9.32 | 9.46 | 9.55 | 11.16 | 11.13 |
| mard- | | | | | | | | |
| based | | | | | | | | |
| Autocor- | 7.53 | 7.54 | 8.09 | 8.10 | 8.54 | 8.53 | 8.45 | 8.41 |
| relation- | | | | | | | | |
| based | | | | | | | | |

Unfortunately, the method proposed cannot be applied to OFMT-SS. As noted before, while in FMT-SS the spreading coefficients belong to a continuous set, in OFMT-SS one is limited to a discrete set, which cannot be generated by point-wise multiplying by the columns of the DFT matrix. Instead of using the DFT matrix, an alternative approach is to point-wise multiply ζ₀ by the columns of a Hadamard matrix. This generates an orthogonal set of multi-code vectors based on an improved or optimized spreading gain vector. Unfortunately, only the first two columns of the Hadamard transform introduce a linear phase shift to ζ₀. These two columns result in a good PAPR performance, but the other multi-code vectors result in much higher PAPR. This can be seen in the first row of Table II. When one (1) or two (2) multi-code vectors are used, the PAPR of the Hadamard multi-coded waveform remains low, but as the number of multi-codes increases, the PAPR increases dramatically. For this reason, an alternative approach is proposed for the cases where a larger number of multi-codes should be used.

To devise a manageable design, one can start with a proper choice of the vector ζ, say ζ₀, and use this choice and its circularly-shifted versions as a set of codes for multi-code signaling. Given the fact that the elements of ζ are limited to the choices of +1 and −1, however, one may note that there is no choice of ζ₀ that can lead to a set of perfectly orthogonal codes. Thus, one can argue that a reasonably good choice of ζ₀ may be the one that minimizes the correlations between ζ₀ and its circularly shifted versions. Given this argument, for the present design, one can set the cost function in the simulated annealing algorithm to be the sum of the magnitude squares of the non-zero lag cyclic autocorrelation coefficients of

$$J = {\sum }_{i = 1}^{L - 1} {\vert {ζ}_{0}^{T} {ζ}_{ℓ} \vert}^{2} \qquad ( 28 )$$

$$where$$

$${ζ}_{ℓ} = {[ \begin{matrix}{ζ}_{ℓ} & {ζ}_{ℓ + 1} & ⋯ & {ζ}_{L - 1} & {ζ}_{0} & {ζ}_{1} & ⋯ & {ζ}_{ℓ - 1}\end{matrix} ]}^{T} . \qquad ( 29 )$$

This design leads to a set of spreading gain vectors that are approximately/quasi orthogonal.

Using a set of spreading gain vectors that are quasi orthogonal for the multi-code vectors incurs a fraction of a decibel of loss in SER performance when compared to the case where multi-codes are perfectly orthogonal. Numerical simulations that confirm this point are presented in Section VI. An analytical justification of this small SER performance loss has been reported, where it is observed that even for relatively large code cross-correlations (e.g., up to 35%), the loss in error rate performance remains below 1 dB. See B. Nelson and B. Farhang-Boroujeny, “Theoretical Analysis of Multi-Coding with Arbitrary Correlations Among the Codes,” in IEEE Transactions on Communications, doi: 10.1109/TCOMM.2026.3665758.

In OFMT-SS, with code length L, for a given transmission, the number of multi-codes in use can be any value M in the range 1 to L. If a BPSK symbol is added to modulate each of the individual codes, one will have a biorthogonal signaling. In this case, the transmission rate will be B=log ₂ M+1 bits per code interval.

Construction of a set of quasi orthogonal codes as discussed above offers the following advantages. Firstly, the PAPR of synthesized multi-code signal remains moderately low and nearly independent of the number of multi-codes in use, M. Reasonings are presented in the section entitled “PAPR Invariance of Mult-Codes” provided later below. Secondly, it allows a low complexity implementation of the receiver. Details of this implementation is presented in the section entitled “Low Complexity Implementation of the Receiver” provided later below.

To appreciate the multi-code design herein proposed, the PAPR values that it achieves are examined. In this study, an OFMT-SS system designed with L=128 subcarriers was used. Table II compares both spreading gain design approaches discussed in this disclosure. As shown, the first design for a single code may be preferred only when the number of multi-codes is relatively small (e.g., four or less). Note that four codes translates to B=log₂ 4+1=3 bits per code interval. For a larger number of multi-codes, the second design performs significantly better. It should be noted that there is a small increase in PAPR as the number of codes grows, which is caused by the interaction of the codes in adjacent symbols.

### IV. Clipping for PAPR Reduction

Many PAPR reduction methods, mostly intended for use with OFDM signals and FBMC offset QAM signals, have been suggested in the literature. These methods include code and spreading gain design, clipping, non-linear companding, and tone reservation (TR) and tone injection (TI), among others. The circularly-shifted multi-coding method discussed in the previous section may be classified as a spreading gain design method. Among the other PAPR reduction methods, the non-linear companding method or clipping method may be used to further reduce the PAPR beyond the result obtained through the spreading gain design. Although non-linear companding has been shown to have exceptional PAPR reduction performance, it requires that the channel equalization be applied at the receiver before removing the companding effect. Besides increasing the complexity of the receiver, this removes some of the desirable properties of OFMT-SS that lead to robust performance in harsh environments. An example of such properties is the use of normalized matched filter which blindly removes strong partial-band interferers.

Clipping, as the name implies, removes the synthesized signal peaks that are above a certain threshold to reduce PAPR. If the signal is directly clipped to a threshold, a significant out-of-band energy may be generated. To limit the out-of-band energy, clipping can be done by adding a passband pulse that covers the band of transmission, but has a negated amplitude of each signal peak. This assures a minimum out-of-band energy. Alternatively, the signal can be repeatedly clipped and filtered to minimize the out-of-band energy.

Clipping naturally introduces some distortion and, as a result, some degradation in performance should be expected. In OFDM, to keep such distortion minimal, especially when large symbol constellations (like 64-QAM or larger) are in use, only a small PAPR reduction (on the order of 1 or 2 dB) may be possible. This is significantly different in OFMT-SS where symbol constellations are limited to BPSK and QPSK as well as multicoding use. In addition, the despreading at the receiver removes most of the induced in-band clipping noise. As a result, clipping allows a significant reduction of PAPR in OFMT-SS with minimal impact on its performance. The numerical results presented in the later parts of this disclosure confirm this point.

### A. Error Vector Magnitude

In the context of PAPR, in OFDM, the error vector magnitude (EVM) is defined as the RMS of the error between the distorted symbols resulting from clipping effect and the original symbols. Here, what is studied is the EVM of the individual chips at OFMT-SS subcarriers as well as the EVM after correlating the received signal with the multi-code spreading gain vectors (i.e., after despreading). By evaluating the EVM before and after correlation, one can compare the OFMT-SS performance with OFDM in the context of PAPR reduction and show the robustness of the former.

Let ζₖ[n]=j^{k}γₖ[n] be the k^{th} chip of the n^{th} information symbol, where γₖ[n] is the corresponding spreading gain. Here ζₖ[n]∈{−1,1}. After applying a clipping noise v(t) to the transmit signal, the received chip, discounting channel noise, is

$${\hat{ζ}}_{k} [ n ] = {ζ}_{k} [ n ] + {ν}_{k} [ n ] , \qquad ( 30 )$$

$$where$$

$${{ν}_{k} [ n ] = {h}_{k} ( t ) ★ν ( t ) \vert}_{t = nT + r} , \qquad ( 31 )$$

and τ is the symbol timing offset. Considering the fact that the transmit signal is a zero mean random process, one finds that E[vₖ[n]]=0, where E[·] refers to the statistical expectation. Next, to simplify the equations that follow, the symbol index is removed from the involved variables.

The EVM at chip-level of OFMT-SS is defined as

$$\begin{matrix}{EVM}_{chip} = \sqrt{\frac{1}{L} {\sum }_{k = 0}^{l - 1} 𝔼 [ {( {ζ}_{k} + {\hat{ζ}}_{k} )}^{2} ]} \\ = \sqrt{\frac{1}{L} {\sum }_{k = 0}^{l - 1} Var [ {ν}_{k} ]}\end{matrix} . \qquad ( 32 )$$

This equation follows the definition of EVM in OFDM, where the data symbols are equivalent to chips in OFMT-SS.

The symbol level EVM of OFMT-SS, on the other hand, is calculated after correlating the received chips with the associated multi-code vector. The result is

$$\begin{matrix}{EVM}_{symb} = \sqrt{{𝔼 [ ( \frac{1}{L} ( {ζ}^{T} ζ - {ζ}^{T} \hat{ζ} ] ) )}^{2} ]} \\ = \sqrt{𝔼 [ {( \frac{1}{L} {ζ}^{T} ν )}^{2} ]}\end{matrix} \qquad ( 33 )$$

$$where$$

$$ν = {[ \begin{matrix}{ν}_{0} & {ν}_{1} & … & {ν}_{L - 1}\end{matrix} ]}^{T} . \qquad ( 34 )$$

Recalling that E[v]=0 and only adjacent elements of v correlate, thanks to the filtering structure of OFMT-SS, one finds that,

$$\begin{matrix}{EVM}_{symb} = \sqrt{\frac{1}{{L}^{2}} Var [ {\sum }_{k = 0}^{L - 1} {ζ}_{k} {ν}_{k} ]} \\ = \frac{1}{L} \sqrt{{\sum }_{k = 0}^{L - 1} Var [ {ν}_{k} ] + 2 {\sum }_{k = 0}^{L - 2} Cov [ {ζ}_{k} {ν}_{k} , {ζ}_{k + 1} {ν}_{k + 1} ]} \\ \approx \frac{1}{L} \sqrt{{\sum }_{k = 0}^{L - 1} Var [ {ν}_{k} ]}\end{matrix} \qquad ( 35 )$$

where the approximation in the third line follows since the second summation in the second line is significantly smaller than the first summation. Numerical results that confirm this approximation are presented later.

By comparing (32) and (35), one finds that despreading results in a signal to interference ratio (SIR) gain of 10 log L dB. Here, interference comes from the clipping. Thus, a lower EVM allows the use of lower clipping thresholds with a very limited effect on the EVM_{symb} and, as a result, BER performance. This makes clipping an excellent candidate for further reduction of the PAPR in OFMT-SS.

Next, the signal-to-interference-plus-noise ratio (SINR) is studied, where the interference is the clipping noise, and the noise refers to additive channel noise. To determine the SINR, without any loss of generality, it can be assumed that the transmitted symbol (a binary bit taking values ±1) is +1. For clarity of the derivations, one can also assume that at the detector output bits are scaled by \sqrt{ε}, hence, bit (signal) power is equal to ε. Accordingly, the bit estimate can be obtained as

$$\begin{matrix}\hat{s} = \frac{1}{L} {\sum }_{k = 0}^{L - 1} ( \sqrt{ℰ} ( {ζ}_{k} + {ν}_{k} ) + {w}_{k} ) {ζ}_{k} \\ = \sqrt{ℰ} + \frac{\sqrt{ℰ}}{L} {\sum }_{k = 0}^{L - 1} {ν}_{k} {ζ}_{k} + \frac{1}{L} {\sum }_{k = 0}^{L - 1} {w}_{k} {ζ}_{k}\end{matrix} . \qquad ( 36 )$$

In the right-hand side of (36), the signal portion is the first term, the interference is the second term, and the channel noise is the third term.

A statistical analysis of the noise terms wₖ is presented in the section entitled “Noise Correlation Properties at the Despreader Input” provided later below. It is shown that the noise terms wₖ are a set of zero-mean independent and identically distributed (IID) random variables, with the autocorrelation/covariance matrix

$${C}_{ww} = \frac{{σ}^{2}}{2} I \qquad ( 37 )$$

where σ² is the one-side power spectral density of the channel noise.

An analysis of the clipping noise terms vₖ turns out to be challenging. One can take note that, for most cases of interest, the clipping noise has a negligible impact on the receiver performance. With this point in mind, to allow the following derivations and analysis, it is assumed that the clipping noise samples vₖ are also zero-mean and IID and have the covariance matrix

$${C}_{νν} = {EVM}_{symb}^{2} I . \qquad ( 38 )$$

Moreover, one can assume that the channel noise samples wₖ and the clipping noise samples vₖ are two independent sets.

Making use of (37) and (38) and taking note that ζₖ∈[−1,1], it is straightforward to show that

$${σ}_{c}^{2} = ℰ {EVM}_{symb}^{2} \qquad ( 39 )$$

$$and$$

$${σ}_{n}^{2} = \frac{{σ}_{w}^{2}}{L} , \qquad ( 40 )$$

$$where {σ}_{c}^{2}$$

is the variance of the second term in the right-hand side of (36), i.e., the clipping noise term, and

$${σ}_{n}^{2}$$

is the variance of the third term in the right-hand side of (36), i.e., the channel noise term.

Making use of the above results, what is obtained is

$$\begin{matrix}SINR = \frac{ℰ}{{σ}_{c}^{2} + \frac{{σ}_{w}^{2}}{L}} \\ = \frac{1}{SNR \times {EVM}_{symb}^{2} + 1} \times SNR\end{matrix} , \qquad ( 41 )$$

$$where$$

$$SNR = L \frac{2 ℰ}{{σ}^{2}} \qquad ( 42 )$$

is the SNR at the receiver output. The numerical results presented later reveal that, in typical applications of OFMT-SS, the SNR degradation resulting from clipping remains negligible, i.e., SNR×EVM²_{symb}<<1, hence, SINR≈SNR.

### B. Clipping Algorithm

One can formulate a clipping algorithm that is based on (e.g., a modified version or adaptation of) one of a number of previously-reported clipping algorithms, for example, a previously-reported algorithm described in B. Farhang-Boroujeny, Signal processing techniques for software radios, 2nd ed., Lulu, 2010. Here, the peaks in the transmit signal can be removed by adding a pulse in the opposite direction of each peak. The pulse is designed to have most of its energy in the band of transmission, and hence, is designed to minimize any out-of-band emissions. Peaks are selected as any portion of the signal that is above a threshold, where the threshold is chosen to limit the PAPR to a target level μ in dB. Similar to the observations for OFDM, it was found that sampling at a rate of Q=4L/T samples/s, i.e., four times above the Nyquist rate, is sufficient.

By carefully designing the cancellation pulse, the out-of-band energy of the clipped signal can be suppressed to an acceptable level. To have good out-of-band energy suppression properties, the cancellation pulse will typically have a longer duration than the portion of the signal that must be clipped. As a result, adding the cancellation pulse to the signal may create new peaks at other time instants. To resolve these new peaks, the clipping process may be repeated a number of times. After applying the cancellation pulses for a predetermined number of iterations P, the signal is hard-clipped to the threshold. Since signal peaks in the processed signal are less frequent and are likely to be less severe than those in the original signal, hard-clipping them causes a much smaller increase in out-of-band emissions than hard-clipping the original signal.

### C. Pulse Design

For the peak cancellation pulse, a Kaiser window-based bandpass filter whose pass and transition bands are limited to the transmission band is chosen. This allows for good out-of-band energy suppression for relatively short cancellation pulse lengths. Similar results can be expected from using other filter design approaches such as equiripple filters and Prolate window-based designs.

The peak cancellation is applied to the OFMT-SS at baseband, i.e., before radio frequency (RF) modulation. Accordingly, the Kaiser filter should be a low-pass filter that covers the baseband of the OFMT-SS signal. For this low-pass filter, what is chosen is a filter order K, a desired stopband attenuation Ψ (e.g., Ψ=60 dB), and a stopband edge f₂. The stopband edge is chosen to be at the stopband edge of the OFMT-SS filter bank. The use of this stopband restricts the pass and transition bands of the clipping pulse to be within the transmission band. The passband edge of the filter f₁ can then be determined based on these parameters using the Kaiser order equation. This leads to

$${f}_{1} = {f}_{2} - \frac{Ψ - 7.95}{14.26 K} . \qquad ( 43 )$$

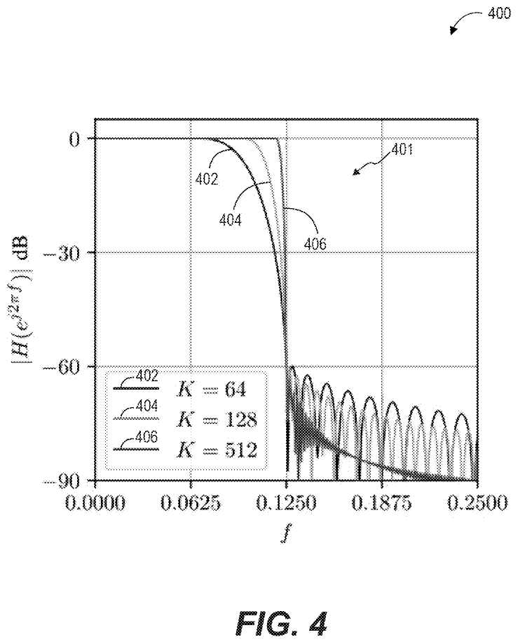

FIG. 4 is a graph 400 of a number of magnitude responses 401 of respective clipping removal pulses of different orders K, according to one or more examples. Magnitude responses 401 of graph 400 include a magnitude response 402 associated with K=64, a magnitude response 404 associated with K=128, and a magnitude response 406 associated with K=512. In all cases, the pulses were designed with a stopband attenuation of 60 dB. As is apparent, as the pulse order increases, the transition band of the filter gets narrower as one would expect. By using a pulse with a narrower transition band, the clipping energy is more evenly distributed across the whole band of transmission. On the other hand, a higher order pulse increases the complexity of cancelling signal peaks because more operations are required to scale and add the cancellation pulse to the signal, and more signal samples are affected by each peak cancellation event.

### V. Numerical Examples

In order to get some insight to the outcome of code designs proposed in Section III and the clipping method developed in Section IV, some numerical results are presented in this section. For the results presented in this section and the next section, a prototype square-root (SR) Nyquist filter with roll-off factor α=1 is used, designed according to the previously-reported algorithm described in Section 4.4.4 of the above associated reference.

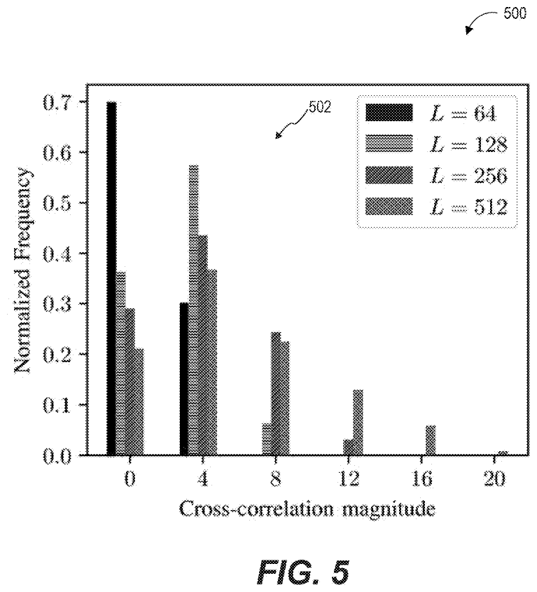

FIG. 5 is a plot 500 of grouped histograms 502 of cross-correlations associated with choices of multi-codes of different lengths L. As is apparent, for the case L=64, there are two values of cross-correlations that are observed, 0 or 4. For the case L=128, the observed cross-correlation values are 0, 4, or 8. Similar observations can be made for the remaining choices. The fact that the cross correlations are all multiples of 4 relates to the specific choices of L values. A workout showing the specific values that the cross-correlation terms may take for different choices of L is presented in the section entitled “Noise Correlation Properties at the Despreader Input” provided later below. In particular, when L is a multiple of 4, the cross-correlations can take values that are only multiples of 4, matching the observation shown in FIG. 5.

To quantify the cross-correlation values in FIG. 5, they should be compared against the magnitude square of the respective code set. Recalling (22), the magnitude square has the value of

$${\overline{γ}}^{H} \overline{γ} = L . \qquad ( 44 )$$

For these comparisons, one may equivalently look at the normalized values of the cross-correlations. For instance, it can be observed from FIG. 5 that in the case where L=64, about 70% of the codes have a normalized cross-correlation of 0 (i.e., they are perfectly orthogonal) and the remaining codes have a normalized cross-correlation of

$$\frac{4}{64} = 0.0625 ,$$

which indicates these remaining codes are nearly orthogonal. Similar workouts on the results in FIG. 5 reveal that the multi-code design that is proposed in this disclosure leads to nearly orthogonal codes with the normalized cross-correlations reducing as the code length L increases.

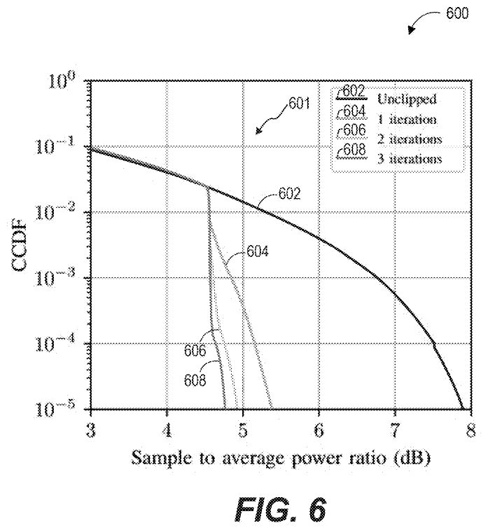

FIG. 6 is a plot 600 of complementary cumulative distribution function (CCDF) curves 601 of the instantaneous power of the synthesized signal normalized by its average power, according to one or more examples. A CCDF curve 602 is depicted for the original signal (i.e., unclipped OFMT-SS signal), as well as CCDF curves 604, 606, and 608 associated with running P=1, 2, and 3 iterations of the clipping algorithm for a pulse order K=64, L=128, and a clipping threshold p=4.5 dB. Here, no final hard clipping is applied. From these results, one can observe that just one iteration of the clipping algorithm significantly reduces the frequency and severity of signal peaks, and that two and three iterations have very similar performance. As a result, a final hard clipping of the signal, especially after the second iteration or more, should have a small effect on the performance of OFMT-SS waveform. The effect of hard clipping after each iteration can be observed, confirming the above assertion, by examining the PSDs of the resulting signals.

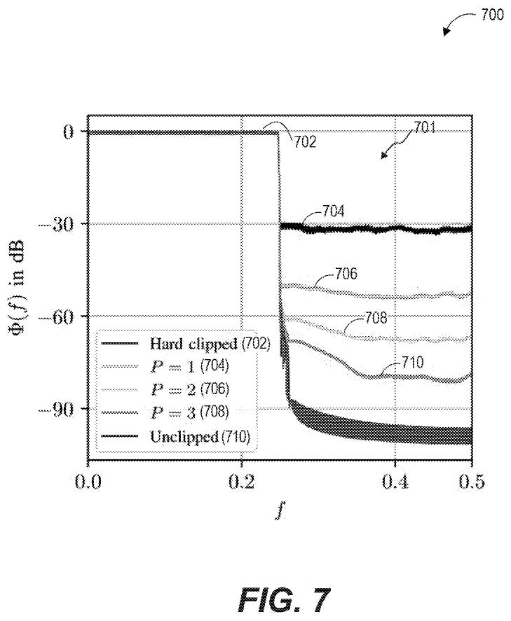

FIG. 7 is a plot 700 of PSD results 701 before and after applying a hard clipping algorithm and a peak-to-average power ratio (PAPR) reduction algorithm, according to one or more examples. In plot 700, a PSD result 702 of an original signal (hard-clipped, no clipping algorithm iterations) and PSD results 704, 706, and 708 of signals after respective 1^{st}, 2^{nd} and 3^{rd} iterations of the clipping algorithm are shown. Plot 700 also includes PSD result 710 of a signal where direct hard clipping is applied without any clipping algorithm application. Additional parameters used to obtain PSD results 701 include μ=4.5 dB, L=128, and K=64. From FIG. 7, one can observe that the proposed clipping method successfully limits the out-of-band signal energy. After just one iteration (i.e., P=1), it reaches −50 dB, and after two iterations, it reaches −60 dB. On the other hand, directly hard clipping the original signal at this threshold results in an out-of-band signal energy of about −30 dB (e.g., likely acceptable). From these results, it is understood that the peaks can be effectively removed in 1 or 2 iterations.

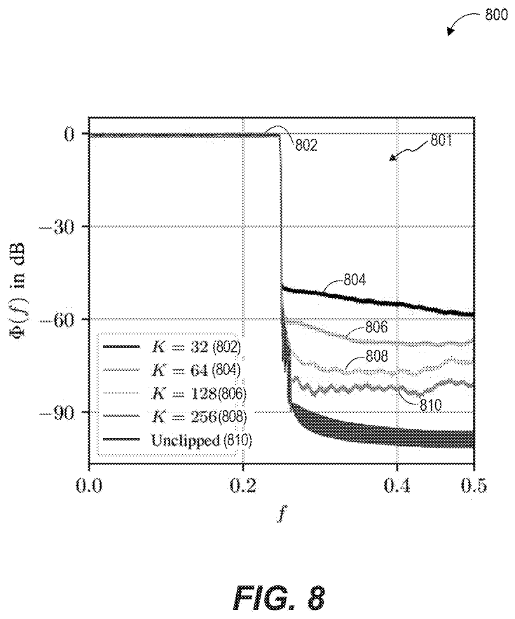

To determine an effective clipping pulse length, the out-of-band signal energy for several pulse orders K is studied. Here, the clipping algorithm is run for two (2) iterations and then the signal is hard-clipped to the threshold. The PSDs of this experiment are shown in FIG. 8.

FIG. 8 depicts a plot 800 of PSD results 801 before and after applying the PAPR reduction algorithm for different clipping pulse orders K, according to one or more examples. PSD results 801 relate to the case where a threshold μ of μ=4.5 dB is chosen. In plot 800, a PSD result 802 is associated with a clipping pulse order K=32, a PSD result 804 is associated with a clipping pulse order K=64, a PSD result 806 is associated with a clipping pulse order K=128, and a PSD result 808 is associated with a clipping pulse order K=256. Plot 800 also includes a PSD result 810 associated without any application of the clipping algorithm. It can be observed that, as the pulse order increases, the out-of-band energy decreases, understandably. However, the improvement in out-of-band energy becomes less significant for higher choices of K, which suggests that a moderate choice of pulse order 32 or 64 may be sufficient. An out-of-band energy of around −50 or −60 dB or better may be sufficient in most of the applications.

Next, to study how the performance changes with clipping threshold, one can recognize that the performance is dependent on the number of iterations P and clipping pulse order K. By increasing these parameters, lower PAPR thresholds can be achieved at the cost of increased computational complexity. To demonstrate the performance at different clipping thresholds, K=64 is chosen and the PSDs for hard clipping after P=1,2 iterations are shown.

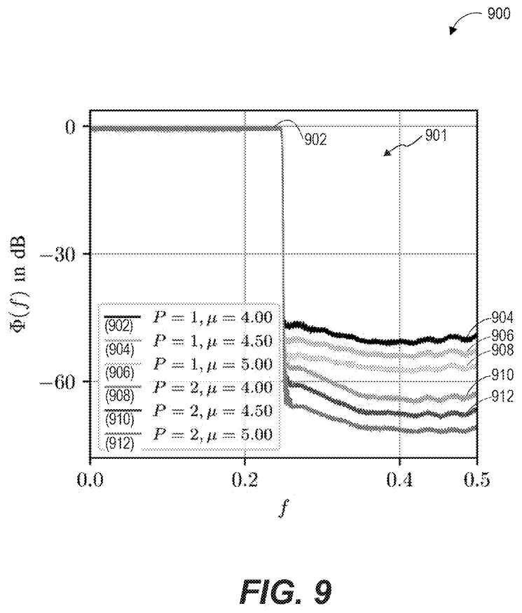

The PSDs are shown in FIG. 9.

FIG. 9 is a plot 900 of PSD results 902 after applying the PAPR reduction algorithm for different iterations P and clipping thresholds μ, according to one or more examples. In plot 900, a PSD result 902 is associated with 1 iteration (P=1) and a clipping threshold μ of 4.00, a PSD result 904 is associated with 1 iteration (P=1) and a clipping threshold μ of 4.50, a PSD result 906 is associated with 1 iteration (P=1) and a clipping threshold μ of 5.00, a PSD result 908 is associated with 2 iterations (P=2) and a clipping threshold μ of 4.00, a PSD result 910 is associated with 2 iterations (P=2) and a clipping threshold μ of 4.50, and a PSD result 912 is associated with 2 iterations (P=2) and a clipping threshold μ of 5.00. From FIG. 9, one can observe that decreasing the clipping threshold tends to increase the out-of-band energy, as one would expect.

As a final result, Table III presents a set of results showing how the choice of clipping threshold impacts EVM_{chip} and EVM_{symb}. These results correspond to the case where a biorthogonal signaling is used, L=128, K=64, and P=2. As one would expect, both EVMs increase as the clipping threshold decreases. Nevertheless, even for a threshold as low as 3.75 dB, EVM_{symb} remains very small. If one substitutes such values and a typical SNR value in the range of 10 to 20 dB in (41), it is found that the SNR loss arising from PAPR reduction translates to a very small value (e.g., less than 0.1 dB). The SER results presented in the next section confirm this negligible loss.

TABLE III
EVM_{chip} AND EVM_{symb} RESULTS FOR
DIFFERENT CLIPPING THRESHOLDS μ.

| Threshold (dB) | EVM_{chip} | EVM_{symb} |
|---|---|---|
| 3.75 | 0.1174 | 0.0094 |
| 4.00 | 0.1034 | 0.0085 |
| 4.25 | 0.0903 | 0.0075 |
| 4.5 | 0.0775 | 0.0066 |
| 4.75 | 0.0655 | 0.0057 |
| 5.00 | 0.0548 | 0.0049 |

### VI. Bit Error Rate (BER) and Symbol Error Rate (SER) Results

In this section, the study of OFMT-SS waveform is extended by looking at a few examples of its BER and SER. In each case, an OFMT-SS signal with L=128 is used. The code designs for single-code and multi-codes follow those presented in Section III.

### A. Single-Code Performance

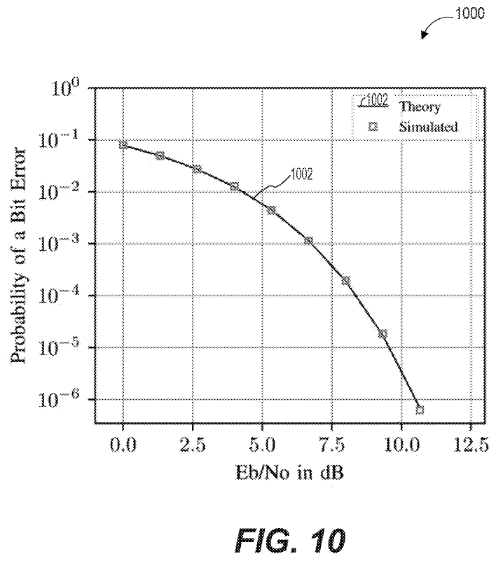

For the single code case, the method discussed in Section IV-A is used to design a spreading gain set. The BER of this system transmitting quadrature phase shift keying (QPSK) information symbols is plotted against Eb No in FIG. 10.

FIG. 10 is a plot 1000 of a simulated bit error rate (BER) curve of single-code OFMT-SS, according to one or more examples, and also includes a theoretical QPSK BER curve 1002 for comparison. In plot 1000, the simulated BER curve is formed by small square marker points, which indicate a strong match with theoretical QPSK curve 1002. This demonstrates the Nyquist (e.g., no ISI) property of the OFMT-SS waveform. The receiver used is a matched filter, followed by a sampler that takes signal samples at the peak of the system impulse response.

### B. Multi-Code Performance

For the multi-coded case, the symbol error rate (SER) is evaluated instead of the bit error rate, which allows for easy comparison with SER probabilities.

Using a system with L=128 multi-code vectors, a maximum bit rate of log₂(L)+1=8 bits per code interval is achieved. One may choose to use a subset of the multi-codes, resulting in a smaller number of bits B per code interval.

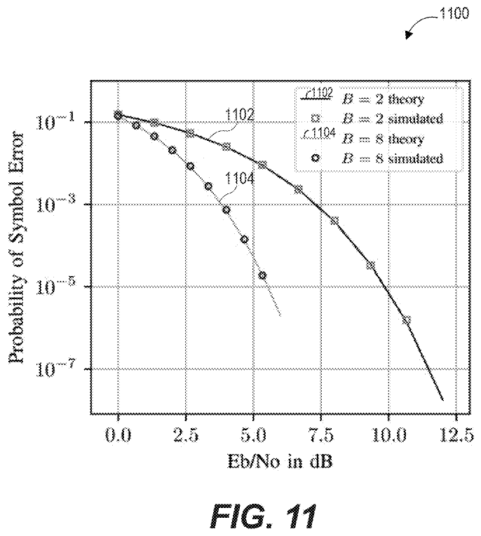

FIG. 11 is a plot 1100 of simulated symbol error rate (SER) curves of multi-code OFMT-SS, according to one or more examples, and also includes orthogonal theoretical curves for comparison. In plot 1100, a simulated SER curve associated with B=2 bits per symbol is formed by small square marker points, which reveal consistency with a theoretical curve 1102; and a simulated SER curve associated with B=8 bits per symbol is formed by small circle marker points, which reveal consistency with a theoretical curve 1104. From FIG. 11, one can observe that, although the code vectors are not perfectly orthogonal, the loss between the orthogonal theory curve and the simulated SER, using quasi-orthogonal code vectors, is very small/unnoticeable. This observation is in line with the findings in Section V. Many theoretical works published confirm the same findings for a few special cases through exact error probabilities or upper bound derivations.

### C. PAPR Reduction Impact

To observe the impact of the clipping on the SER performance, a number of clipping thresholds are considered and their performance is compared against the theoretical biorthogonal signaling theory curve.

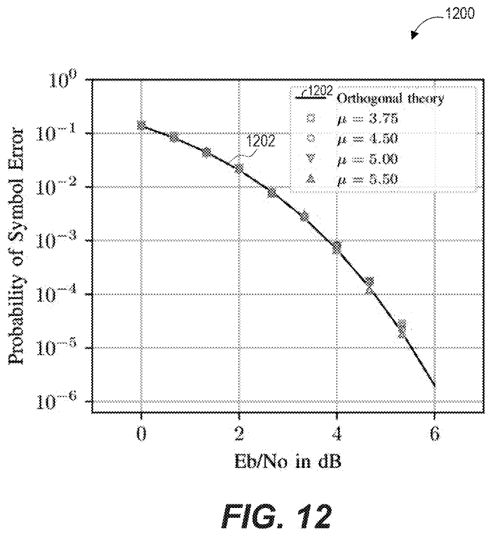

FIG. 12 is a plot 1200 of simulated SER curves associated with different PAPR reduction thresholds μ, according to one or more examples. The results are associated with the example case where L=128, K=64, P=2, multi-codes and biorthogonal signaling are deployed, and B=8 bits are transmitted per code interval. In plot 1200, a simulated SER curve associated with a clipping threshold p of 3.75 is formed by small square marker points, which reveal consistency with a theoretical curve 1202; a simulated SER curve associated with a clipping threshold μ of 4.50 is formed by small circle marker points, which also reveal consistency with theoretical curve 1202; a simulated SER curve associated with a clipping threshold μ of 5.00 is formed by small inverted triangle marker points, which further reveal consistency with theoretical curve 1202; and a simulated SER curve associated with a clipping threshold μ of 5.50 is formed by small triangle marker points, which also reveal consistency with theoretical curve 1202. From FIG. 12, one can observe that there is only a very small loss introduced by clipping (e.g., hard clipping applied after the second iteration of the clipping algorithm), confirming the findings in Section V.

### D. Multi-Path Channel Impacts

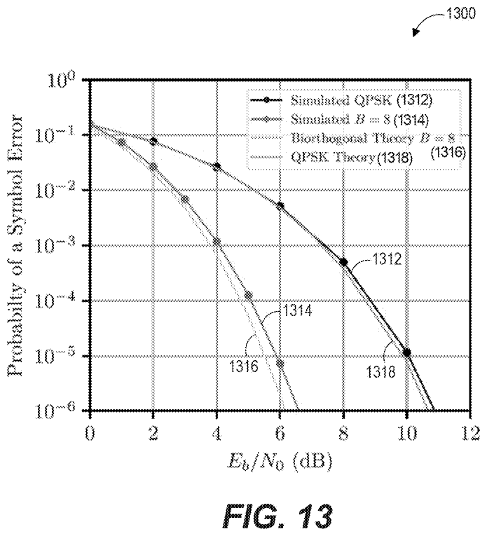

To see the impacts of a multi-path channel, the performance over a long-term evolution (LTE) Extended Vehicular A (EVA) wireless channel model is considered. The simulation uses 20 MHz of bandwidth and has a subcarrier spacing of 156.25 kHz. The EVA channel model has a −10 dB delay spread of 1090 ns, which results in an approximate coherence bandwidth of 900 kHz. In this case, the channel is approximately flat-fading over each individual subcarrier band, hence, a single tap equalizer per subcarrier should be sufficient for good performance. Here, the single tap maximum ratio combiner (MRC) of the FMT-SS scheme is applied. Channel fading, Doppler, and channel estimation errors are neglected. The SER curves, along with the relevant AWGN theoretical curves, are shown in FIG. 13.

FIG. 13 is a plot 1300 of simulated SER curves for single-code and multi-code OFMT-SS over LTE EVA channels as compared to theoretical additive white Gaussian noise (AWGN) curves, according to one or more examples. In plot 1300, a simulated QPSK curve 1312 and an associated QPSK theoretical curve 1318 are depicted, and a simulated curve 1314 (B=8 bits) and an associated biorthogonal theoretical curve 1316 are also depicted. For the single-coded QPSK transmission, there is only a small loss, arising from a slight frequency selectivity of the channel over each subcarrier band. For the multi-coded case, additional loss is observed which can be attributed to a decrease in the orthogonality of the multi-code vectors after passing through a multipath channel. It is concluded the OFMT-SS waveform exhibits an exceptional performance in multi-path channels for both single and multi-coded transmission schemes, especially when the channel coherence bandwidth is much larger than the symbol rate and an effective maximum ratio combiner is used.

### PAPR Invariance of Multi-Codes

In this section, it is shown that the PAPR minimally varies between different choices of the multi-codes when such codes are generated according to the method discussed in Section III-B. To this end, there is a close relationship between the crest-factor of m̅(t) and the PAPR of the synthesized signal. Then, the crest-factor m̅(t) is considered and shown to be invariant of the choices of the multi-code vectors when they are selected according to (29).

A proof of the latter statement can be made by first noting that

$${\overline{m}}^{′} ( t ) = {\sum }_{k = 0}^{L - 1} {ζ}_{k} {e}^{j 2 π {f}_{k} t} \qquad ( 45 )$$

has the same crest-factor as m̅(t). This follows if one takes note that m̅(t) is obtained from m̅′̅(t) by adding a linear phase to the coefficients ζₖ, namely, the addition of the j^{k} coefficients in (22). Such linear phase results in a signal shift which clearly has no impact on its crest-factor. On the other hand, taking note that (45) is an inverse Fourier series, a circular shift of its coefficients translates to a modulation, i.e., multiplication of the synthesized signal by an exponential factor e^{j2πfct}, where f_{c} is the modulation frequency. This also does not change the crest-factor of the resulting signal.

### Low Complexity Implementation of the Receiver

A generic implementation of the receiver involves correlation of the signal samples at the output of the analysis filter bank, after equalization, with each the multi-codes separately. For a code length L and when the maximum number of multi-codes, equal to L, are used, completing all of the correlations involves L² multiply and add operations. The above choice using multi-codes allows one to reduce this complexity to about Llog₂ L operations through use of fast Fourier transforms (FFTs). For completeness of the discussion, details of the correlator are presented.

Let J be an L×L circulant matrix with the first column ζ₀ and y denote the vector of outputs of the analysis filter bank, after equalization. The vector of correlations of interest is given by

$$c = {J}^{H} ( {b}^{*} \text{?} y ) . \qquad ( 46 )$$

Next, since J is a circulant matrix, it may be expanded as,

$$J = {\text{?}}^{H} Λ \text{?} \qquad ( 47 )$$

where Λ is a diagonal matrix whose diagonal elements are obtained by taking the discrete Fourier transform (DFT) of ζ₀ and F is the normalized DFT matrix, satisfying F^{H}F=I. Substituting (47) in (46), what is obtained is

$$c = {\text{?}}^{H} Λ * \text{?} ( b * \text{?} y ) . \qquad ( 48 )$$

Implementation of (48) involves N multiplications, to perform (b⊙y), N log₂ N to perform multiplications with F and F^{H}, and N multiplications to include Λ* in the operations.

### Noise Correlation Properties at the Despreader Input

Consider a multi-coded OFMT-SS system where the spreading gain vector at the n^{th} code interval is

$$γ [ n ] = {[ {γ}_{0} [ n ] {γ}_{1} [ n ] … {γ}_{L - 1} [ n ] ]}^{T} . \qquad ( 49 )$$

The signal at the kth analysis filter bank output is given by

$${y}_{k} ( t ) = {( j )}^{k} {h}_{k}^{*} ( - t ) ★ ( {\sum }_{n = - ∞}^{∞} [ {γ}_{k} [ n ] {h}_{k} ( t - nT ) + {γ}_{k - 1} [ n ] {h}_{k - 1} ( t - nT ) + {γ}_{k + 1} [ n ] {h}_{k + 1} ( t - nT ) ] + {w}^{\text{?}} ( t ) ) , \qquad ( 50 )$$

$$where$$

$${h}_{k} ( t ) = h ( t ) {e}^{j 2 π {f}_{k} t} , \qquad ( 51 )$$

$$\text{?} \text{indicates text missing or illegible when filed}$$

\tilde{w}(t) is a zero mean, complex white Gaussian random process with one-sided power spectral density σ², and it is defined that γ₋₁=γ_{L}=0.

By performing straightforward manipulations and substituting γₖ[n]=j^{k}ζₖ[n], (50) can be rearranged as

$${y}_{k} ( t ) = {\sum }_{m = - ∞}^{∞} {ζ}_{k} [ m ] ( t - mT ) - j {\sum }_{m = - ∞}^{∞} {ζ}_{k - 1} [ m ] {d}_{k - 1}^{*} ( - ( t - mT ) ) + j {\sum }_{m = - ∞}^{∞} {ζ}_{k + 1} [ m ] {d}_{k} ( t - mT ) + {{w}^{\text{?}}}_{k} ( t ) , \qquad ( 52 )$$

$$\text{?} \text{indicates text missing or illegible when filed}$$

where ρ(t) is given in (3), dₖ(t)=d(t)e^{j2πfkt}, d(t) is given in (17), and

$${\tilde{ω}}_{k} ( t ) = {( - j )}^{k} {h}_{k}^{*} ( - t ) ★ \tilde{ω} ( t ) .$$

Next, using (17), one finds that

$$D ( f ) = H ( f ) H ( f - \frac{1}{T} ) , \qquad ( 53 )$$

where H(f) and D(f) are the Fourier transforms of h(t) and d(t), respectively. One also defines

$${D}^{′} ( f ) = D ( f + \frac{1}{2 T} ) ,$$

and take note that converting it to the time domain leads to

$${d}^{′} ( t ) = d ( t ) {e}^{- j \frac{2 π t}{2 T}} . \qquad ( 54 )$$

Moreover, using the definition of f̅ₖ from (8), one finds that

$${d}_{k} ( t ) = {d}^{′} ( t ) {e}^{- j \frac{2 \text{?}}{T} ( k - N + 1 ) t} . \qquad ( 55 )$$

$$\text{?} \text{indicates text missing or illegible when filed}$$

To proceed, it is assumed that h(t) is chosen to be real-valued and symmetric around t=0, i.e., a zero-phase filter. When this condition holds, it is not difficult to show that d′(t) is also a zero-phase pulse and, thus, it is real-valued and symmetric around t=0. Also, (54) and (55) imply that the samples

$${d}_{k} ( nT ) = {d}^{′} ( nT ) = d ( nT ) \qquad ( 56 )$$

are a set of real-valued numbers. Using this result in (52), sampling at t=nT, and recalling that ρ(t) is a Nyquist pulse,

$$\text{?} + j {\sum }_{\text{?}}^{\text{?}} \text{?} \qquad ( 57 )$$

$$\text{?} \text{indicates text missing or illegible when filed}$$

where [symbol] [n] is the sampled complex random variable that originated from the channel noise.

The estimate of ζₖ, [symbol] is obtained by taking the real part of y[n]. Also, taking note that the summation on the left-hand side of (57) is real-valued, what is obtained is

$${\hat{ζ}}_{k} [ n ] = {ζ}_{k} [ n ] - {w}_{k} [ n ] , \qquad ( 58 )$$

where wₖ[n]= [symbol] { [symbol] [n]}. Assuming the channel noise is a zero-mean process, (58) shows that the [symbol] [n] is an unbiased estimate of ζₖ[n].

Next, autocorrelation C_{ww} of the noise vector is given as

$$w [ n ] = [ {w}_{0} [ n ] {w}_{1} [ n ] … {w}_{L - 1} [ n ] ] . \qquad ( 59 )$$

To find C_{ww}, one can begin with the continuous-time vectored random process

$$\overline{w} ( t ) = {[ {\overline{w}}_{0} ( t ) {\overline{w}}_{1} ( t ) … {\overline{w}}_{L - 1} ( t ) ]}^{T} \qquad ( 60 )$$

taking note that

$$\tilde{w} ( t ) = ( w ( t ) ★ {h}^{*} ( - t ) , \qquad ( 61 )$$

where

$$h ( t ) = b ⊙ {[ \begin{matrix}{h}_{0} ( t ) & {h}_{1} ( t ) & ⋯ & {h}_{L - 1} ( t )\end{matrix} ]}^{T} , \qquad ( 62 )$$

b is given by (23), and ⊙ is an element-wise product. Making use of previous results, the autocorrelation of \tilde{w}(t) can be obtained as

$${R}_{\tilde{w} \tilde{w}} ( τ ) = ( {R}_{\tilde{ω}} ( t ) ★ {h}^{*} ( - t ) ★ {h}^{T} ( t ) ) {\vert}_{t = τ} \qquad ( 63 )$$

where R_{\tilde{w}}(t)=σ²δ(t) is the autocorrelation function of \tilde{w}(t). Using (63), the k,l^{th} element of R_{w̅w̅(T)} can be shown to be

$${[ {R}_{\tilde{w} \tilde{w}} ( τ ) ]}_{k , l} = \{ \begin{matrix}{σ}^{2} ρ ( τ ) & for k = l \\ j {σ}^{2} {d}^{*} ( - τ ) & for l = k + 1 \\ - j {σ}^{2} d ( τ ) & for l = k - 1 \\ 0 & otherwise\end{matrix} \qquad ( 64 )$$

Now, assuming that the channel noise w(t) is a proper (i.e., circularly symmetric) complex Gaussian process, from previously obtained results one will find that the vector \tilde{w}(t) is also a proper complex Gaussian process, hence,

$${R}_{ww} ( τ ) = \frac{1}{2} \text{?} \{ {R}_{\tilde{w} \tilde{w}} ( τ ) \} \qquad ( 65 )$$

where R_{ww}(τ) is the autocorrelation function of w(t)= [symbol] {\tilde{w}(t)}. Also note that

$${C}_{ww} = {R}_{ww} ( 0 ) . \qquad ( 66 )$$

Taking note that ρ(0)=1, d(0) is real-valued, and recalling (64), one obtains equation (37).

### Cross-Correlation Terms

Consider two spreading chip sequences

$${ζ}^{( 0 )} = {[ \begin{matrix}{ζ}_{0}^{( 0 )} & {ζ}_{1}^{( 0 )} & ⋯ & {ζ}_{L - 1}^{( 0 )}\end{matrix} ]}^{T}$$

$${ζ}^{( 1 )} = {[ \begin{matrix}{ζ}_{0}^{( 1 )} & {ζ}_{1}^{( 1 )} & ⋯ & {ζ}_{L - 1}^{( 1 )}\end{matrix} ]}^{T} \\ where$$

$${ζ}_{k}^{( l )} ∈ \{ - 1 , + 1 \}$$

and both ζ⁽⁰⁾ and ζ⁽¹⁾ contain the same number of +1 and −1 elements. The cross-correlation between ζ⁽⁰⁾ and ζ⁽¹⁾ may be written as

$$C = {\sum }_{k = 0}^{L - 1} {x}_{k} \\ where \\ {x}_{k} = {ζ}_{k}^{( 0 )} {ζ}_{k}^{( 1 )} ∈ \{ - 1 , + 1 \} \qquad ( 67 )$$

Next, one can define the sets Xₚ={xₖ|xₖ=+1} and Xₙ={xₖ|xₖ=−1}, and the summations Cₚ=ΣXₚ and Cₙ=ΣXₙ. Note that C_{P}−Cₙ=L and let Cₚ+Cₙ=C. Using the latter two identities, one finds that

$$C = L + 2 {C}_{n} . \qquad ( 68 )$$

This implies that the integer C has the same parity as L.

Now it can be shown that Cₙ is even. For this, start with the trivial case that

$${ζ}^{( 1 )} = {ζ}^{( 0 )} , \qquad ( 69 )$$

where Cₙ=0. Next, ζ⁽¹⁾ is updated by swapping two of its elements. If these elements have the same sign, there will be no change in the value Cₙ. If they have different sign, Cₙ will reduce to −2, since the product terms, xₖ, at both positions becomes negative. Repeating this process of swapping elements, Cₙ only increases or decreases by 2. This implies that Cₙ always remains a negative even number. Hence, C in (68) will take on discrete values in steps of 4. In the case where L is a multiple of 4, the cross-correlation C can take values 0, 4, 8, . . . . Finally, this observation is applicable to the construction of the multi-codes discussed in Section III-B. This is because all circular shifts of ζ⁽⁰⁾ results in vectors in which the number of +1 and −1 elements are preserved.

Thus, a filter bank-based waveform for spread spectrum communications has been disclosed. The proposed waveform is a modified form of filtered multi-tone spread spectrum. In conventional FMT-SS, subcarrier bands are non-overlapping, which results in a recognizable footprint (or spectral signature) in the FMT-SS signal spectra that could reveal characteristics to an unauthorized receiver. The new OFMT-SS waveform adds additional subcarriers to fill in the empty spectra between the adjacent subcarrier bands of FMT-SS, which leads to a substantially flat spectrum. In the disclosure, the choices of spreading gains in OFMT-SS were studied and constraints to impose to the gains to result in a perfectly flat synthesized transmit signal were identified. A method of optimizing the spreading gains was also developed to minimize the PAPR of the synthesized signal. To further reduce the PAPR, the use of signal clipping methods were explored which revealed that, in the particular case of OFMT-SS, PAPR values of as low as 4 dB or smaller was realizable without substantial impact on system performance. System performance was measured by the out-of-band emissions at the transmitter output, and by BER and SER results at the receiver.

### OFMT-SS Transmitter and Transmitter Operation

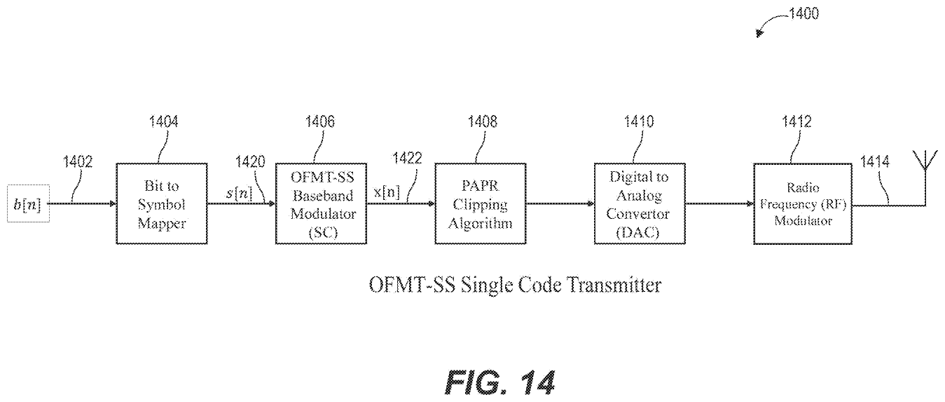

FIG. 14 is a schematic diagram of an OFMT-SS transmitter 1400 with single-code (SC) spreading, according to one or more examples. In one or more examples, OFMT-SS transmitter 1400 comprises transmitter processing circuitry including a bit-to-symbol mapper 1404, an OFMT-SS baseband modulator 1406 with single-code spreading, a PAPR clipping algorithm 1408 (otherwise referred to as a PAPR peak limiter or peak limiter), a digital-to-analog converter (DAC) 1410, and a radio frequency (RF) modulator 1412. An antenna 1414 of OFMT-SS transmitter 1400 may be coupled to an output of RF modulator 1412.

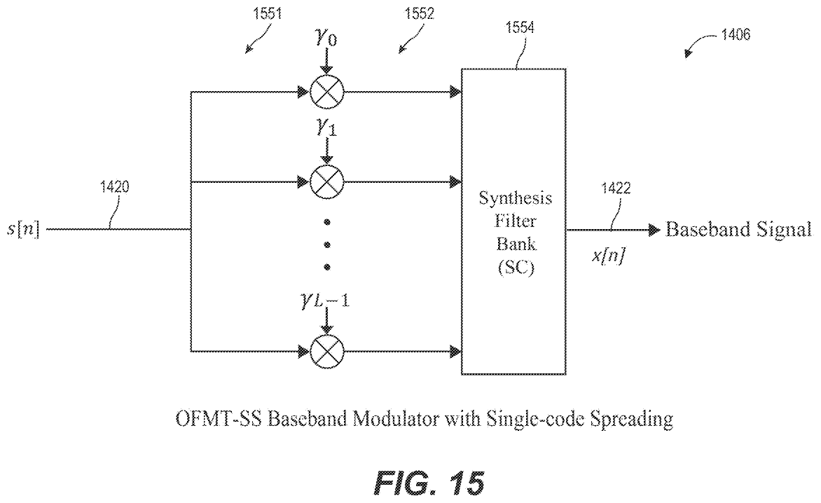

FIG. 15 is a schematic diagram of OFMT-SS baseband modulator 1406 with single-code spreading of FIG. 14, according to one or more examples. In one or more examples, OFMT-SS baseband modulator 1406 includes a set of parallel subcarrier branches 1551, a set of spreading multipliers 1552 of a spreading stage, and an OFMT-SS synthesis filter bank 1554.

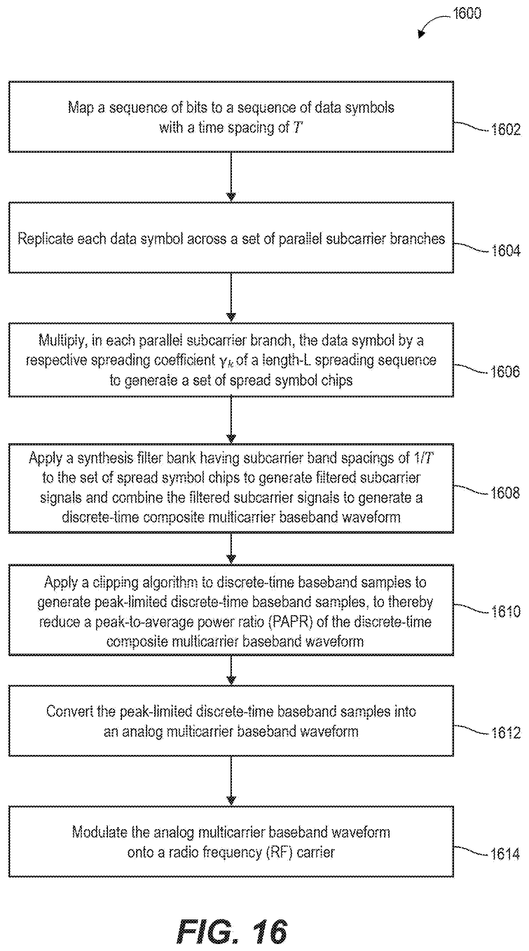

FIG. 16 is a flowchart of a method 1600 of OFMT-SS transmitter processing with single-code spreading, according to one or more examples. In one or more examples, method 1600 is performed using OFMT-SS transmitter 1400 with single-code spreading of FIGS. 14 and 15. In one or more examples, method 1600 and/or operation of OFMT-SS transmitter 1400 of FIGS. 14 and 15 are based on the principles and techniques discussed and shown in relation to FIGS. 1A-1B and 2-13. In one or more examples, the transmitter processing circuitry is implemented using at least one processor (e.g., a DSP) executing processor-executable instructions or dedicated digital hardware circuitry (e.g., an FPGA or ASIC), depending on system requirements.

At an act 1602 of FIG. 16, a sequence of bits is mapped to a sequence of data symbols (e.g., real or complex-valued symbols) with a time spacing of T. With reference to FIG. 14, a sequence of bits b[n] is provided at an input 1402 of bit-to-symbol mapper 1404, which performs the mapping to produce a sequence of data symbols s[n].

At an act 1604 of FIG. 16, each data symbol is replicated across a set of parallel subcarrier branches. With reference to FIG. 14, each data symbol s[n] is provided at an input 1420 of OFMT-SS baseband modulator 1406, and with reference to FIG. 15, the data symbols s[n] are indicated as being replicated or distributed across the set of parallel subcarrier branches 1551 in OFMT-SS baseband modulator 1406.

At an act 1606 of FIG. 16, the data symbol is multiplied, in each parallel subcarrier branch, by an respective spreading coefficient γₖ of a length—L spreading sequence to generate a set of spread symbol chips. With reference to FIG. 15, the data symbol s[n] is multiplied by the set of spreading multipliers 1552 having respective spreading coefficients γ₀, γ₁, . . . , γ_{L-1}, resulting in the generation of the set of spread symbol chips.

At an act 1608 of FIG. 16, a synthesis filter bank having subcarrier band spacings of 1/T is applied to the set of spread symbol chips to generate filtered subcarrier signals, and the filtered subcarrier signals are combined (or summed) to generate a discrete-time composite multicarrier baseband waveform. With reference to FIG. 15, the set of spread symbol chips from the outputs of the set of spreading multipliers 1552 are input to synthesis filter bank 1554. Synthesis filter bank 1554 generates the filtered subcarrier signals and combines the filtered subcarrier signals to generate, at an output 1422, a discrete-time composite multicarrier baseband waveform x[n].

At an act 1610 of FIG. 16, a clipping algorithm is applied to discrete-time baseband samples of the discrete-time composite multicarrier baseband waveform to generate peak-limited discrete-time baseband samples. The clipping algorithm reduces or minimizes a PAPR of the waveform. With reference to FIG. 14, PAPR clipping algorithm 1408 receives the discrete-time baseband samples from output 1422 and generates the peak-limited discrete-time baseband samples at its output.

At an act 1612 of FIG. 16, the peak-limited discrete-time baseband samples are converted into an analog multicarrier baseband waveform. With reference to FIG. 14, DAC 1410 receives and converts the peak-limited discrete-time baseband samples into the analog multicarrier baseband waveform.

At an act 1614 of FIG. 16, the analog multicarrier baseband waveform is modulated onto a radio frequency (RF) carrier to generate an RF signal. With reference to FIG. 14, RF modulator 1412 modulates the analog multicarrier baseband waveform from DAC 1410 onto the RF carrier to generate the RF signal. The RF signal may be transmitted via antenna 1414. In this context, the RF signal may be referred to as a transmitted RF OFMT-SS signal.

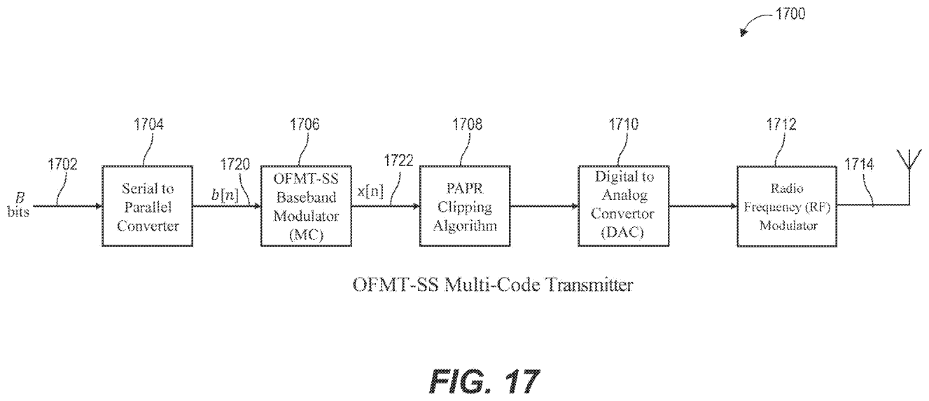

FIG. 17 is a schematic diagram of an OFMT-SS transmitter 1700 with multi-code (MC) spreading, according to one or more examples. In one or more examples, OFMT-SS transmitter 1700 comprises a transmitter processing circuitry including a serial-to-parallel (S/P) converter 1704, an OFMT-SS baseband modulator 1706 with multi-code spreading, a PAPR clipping algorithm 1708 (otherwise referred to as a PAPR peak limiter or peak limiter), a DAC 1710, and an RF modulator 1712. An antenna 1714 of OFMT-SS transmitter 1700 may be coupled to an output of RF modulator 1712.

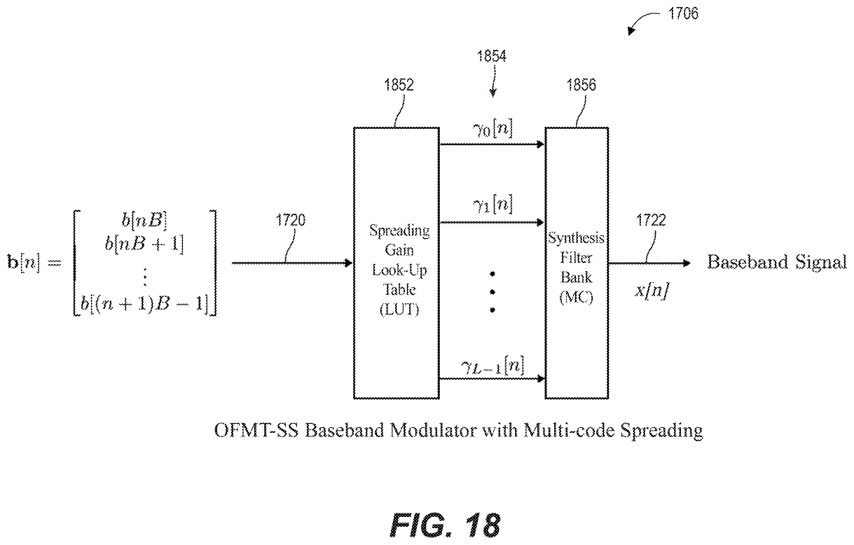

FIG. 18 is a schematic diagram of OFMT-SS baseband modulator 1706 with multi-code spreading of FIG. 17, according to one or more examples. In one or more examples, OFMT-SS baseband modulator 1706 includes a spreading gain look-up table (LUT) 1852 and an OFMT-SS synthesis filter bank 1856.

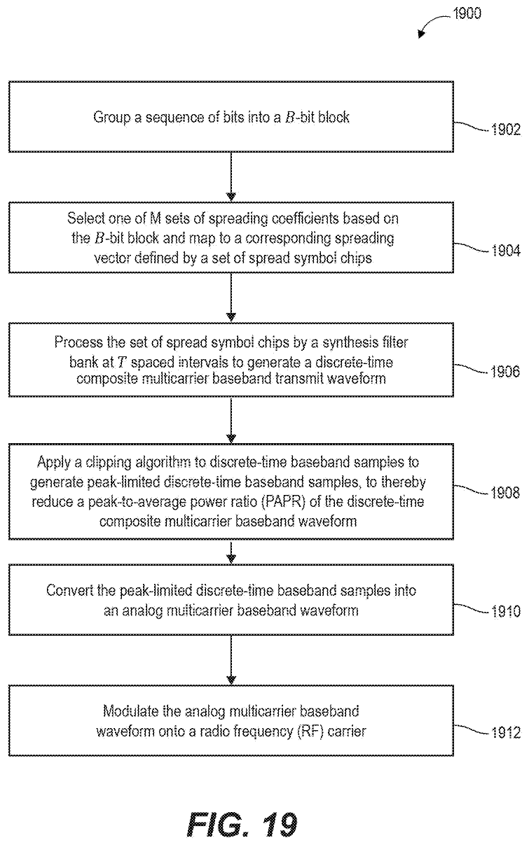

FIG. 19 is a flowchart of a method 1900 of OFMT-SS transmitter processing with multi-code spreading, according to one or more examples. In one or more examples, method 1900 is performed using OFMT-SS transmitter 1700 of FIGS. 17 and 18. In one or more examples, method 1900 and/or operation of OFMT-SS transmitter 1700 of FIGS. 17 and 18 are based on the principles and techniques discussed and shown in relation to FIGS. 1A-1B and 2-13. In one or more examples, the transmitter processing circuitry is implemented using at least one processor (e.g., a DSP) executing processor-executable instructions or dedicated digital hardware circuitry (e.g., an FPGA or ASIC), depending on system requirements.

At an act 1902 of FIG. 19, a sequence of bits is grouped into a parallel bit block (e.g., a B-bit block). With reference to FIG. 17, a sequence of B bits is provided at an input 1702 of serial-to-parallel converter 1704, which groups the B bits to produce the B-bit block at its output, indicated in the figure as b[n]. With reference to FIG. 18, the parallel bit block or b[n] is indicated as b[nB], b[nB+1], . . . , b[(n+1)B−1] at input 1720 of spreading gain LUT 1852 in OFMT-SS baseband modulator 1706.

At an act 1904 of FIG. 19, one of M sets of spreading coefficients is selected based on the B-bit block, to thereby map the B-bit block to a corresponding spreading vector defined by a set of spread symbol chips. With reference to FIG. 18, spreading gain LUT 1852 selects one of M spreading coefficient sets based on the B-bit block, associating the B-bit block with a corresponding spreading vector 1854 (i.e., a codeword) defined by y[n] or [y₀[n], y₁[n], . . . y_{L-1}[n]]. Spreading vector 1854 represents the set of spread symbol chips for the transmitted symbol.

At an act 1906 of FIG. 19, the set of spread symbol chips is processed by a synthesis filter bank at T-spaced intervals to generate a discrete-time composite multicarrier baseband waveform. With reference to FIG. 18, synthesis filter bank 1856 receives, from spreading gain LUT 1852, spreading vector 1854 comprising y₀[n], y₁n], . . . , y_{L-1}[n] which represent the set of spread symbol chips, and maps the spreading vector inputs onto corresponding filtered subcarriers. Synthesis filter bank 1856 combines (i.e., sums) the filtered subcarrier signals to generate a discrete-time composite multicarrier baseband waveform x[n].

At an act 1908 of FIG. 19, a clipping algorithm is applied to discrete-time baseband samples of the discrete-time composite multicarrier baseband waveform to generate peak-limited discrete-time baseband samples. The clipping algorithm reduces or minimizes a PAPR of the waveform. With reference to FIG. 17, PAPR clipping algorithm 1708 receives the discrete-time baseband samples from output 1722 and generates the peak-limited discrete-time baseband samples at its output.

At an act 1910 of FIG. 19, the peak-limited discrete-time baseband samples are converted into an analog multicarrier baseband waveform. With reference to FIG. 17, DAC 1710 receives and converts the peak-limited discrete-time baseband samples into the analog multicarrier baseband waveform.

At an act 1912 of FIG. 19, the analog multicarrier baseband waveform is modulated onto an RF carrier to generate an RF signal. With reference to FIG. 17, RF modulator 1712 modulates the analog multicarrier baseband waveform from DAC 1710 onto the RF carrier to generate the RF signal. The RF signal may be transmitted via antenna 1714. In this context, the RF signal may be referred to a transmitted RF OFMT-SS signal.

### OFMT-SS Receiver and Receiver Operation

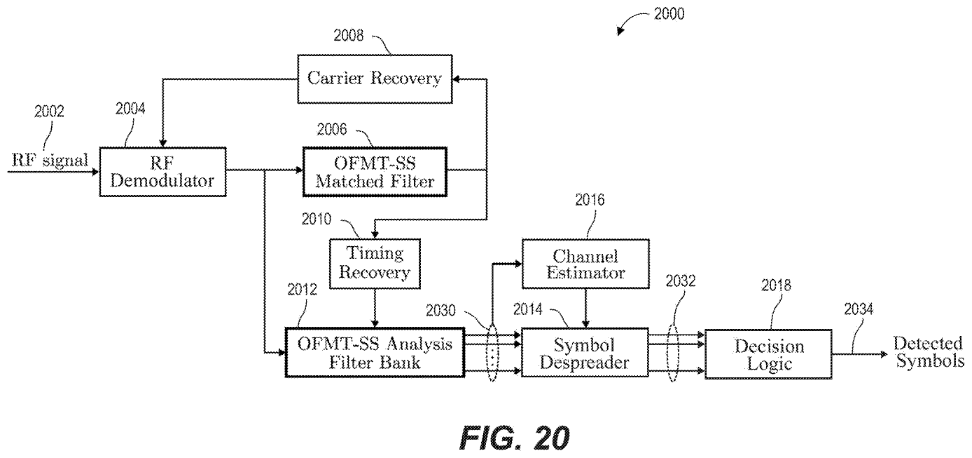

FIG. 20 is a schematic diagram of an OFMT-SS receiver 2000 with single-code despreading, according to one or more examples. In one or more examples, OFMT-SS receiver 2000 comprises receiver processing circuitry including an RF demodulator 2004, an OFMT-SS matched filter 2006, an OFMT-SS analysis filter bank 2012, a symbol despreader 2014, a decision logic 2018, a channel estimator 2016, a carrier recovery block 2008, and a timing recovery block 2010. An antenna of OFMT-SS receiver 2000 may be coupled to an input 2002 of RF demodulator 2004.

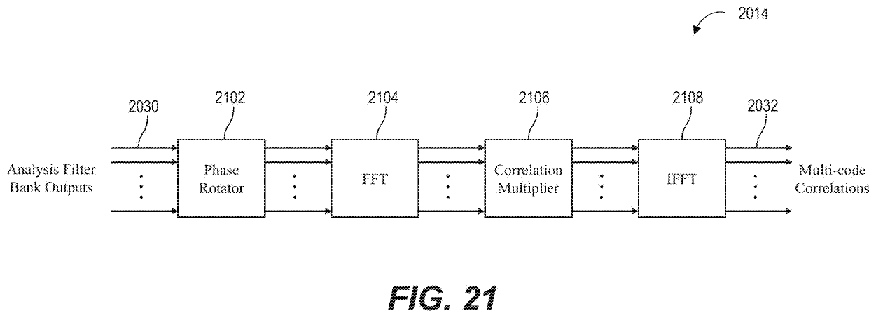

FIG. 21 is a schematic diagram of symbol despreader 2014 of FIG. 20 for multi-code despreading, according to one or more examples. In one or more examples, symbol despreader 2014 for multi-code despreading includes a phase rotator 2102, a Fast-Fourier Transform (FFT) block 2104, a correlation multiplier 2106, and an inverse FFT block 2108.

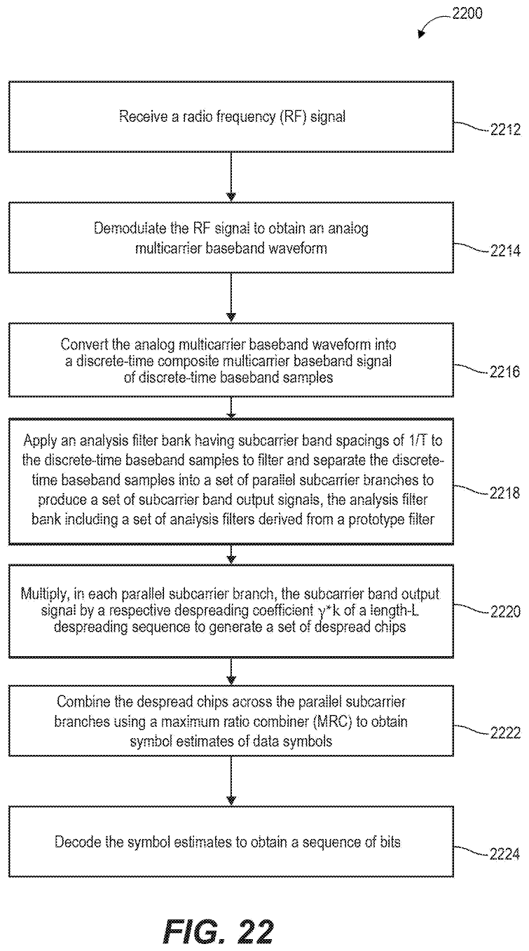

FIG. 22 is a flowchart of a method 2200 of OFMT-SS receiver processing with single-code despreading, according to one or more examples. In one or more examples, method 2200 is performed using OFMT-SS receiver 2000 with single-code despreading of FIG. 20 (e.g., without use of symbol despreader 2014 for multi-code despreading of FIG. 21). In one or more examples, method 2200 and/or operation of OFMT-SS receiver 2000 of FIG. 20 are based on the principles and techniques discussed and shown in relation to FIGS. 1A-1B and 2-13. In one or more examples, the receiver processing circuitry is implemented using at least one processor (e.g., a DSP) executing processor-executable instructions or dedicated digital hardware circuitry (e.g., an FPGA or ASIC), depending on system requirements.

At an act 2212 of FIG. 22, an RF signal is received. In this context, the RF signal is an RF OFMT-SS signal. At an act 2214 of FIG. 22, the received RF OFMT-SS signal is demodulated to obtain an analog multicarrier baseband waveform. At an act 2216 of FIG. 22, the analog multicarrier baseband waveform is converted, using an analog-to-digital converter (ADC), into a discrete-time composite multicarrier baseband signal. The discrete-time composite multicarrier baseband signal is comprised of discrete-time baseband samples. With reference to FIG. 20, RF demodulator 2004 receives the RF OFMT-SS signal at input 2002 and demodulates the signal to obtain the analog multicarrier baseband waveform. RF demodulator 2004 outputs the analog waveform to an ADC (not depicted in FIG. 20), which performs the conversion of the waveform into the discrete-time baseband samples.

At an act 2218 of FIG. 22, an analysis filter bank having subcarrier band spacings of 1/T is applied to the discrete-time baseband samples to filter and separate the discrete-time baseband samples into a set of parallel subcarrier branches, thereby producing a set of subcarrier band output signals corresponding to respective subcarrier bands. The analysis filter band includes a set of analysis filters derived from a prototype filter (e.g., the common or transmitter prototype filter). With reference to FIG. 20, the discrete-time baseband samples (e.g., from the output of the ADC) are input to OFMT-SS analysis filter bank 2012. OFMT-SS analysis filter bank 2012 processes the discrete-time baseband samples to generate the set of subcarrier band output signals. More specifically, within OFMT-SS analysis filter bank 2012, the analysis filters derived from the prototype filter are used to filter and separate the discrete-time baseband samples into the set of parallel subcarrier branches. OFMT-SS analysis filter bank 2012 produces, at its output, the set of subcarrier band output signals corresponding to the respective subcarrier bands.

At an act 2220 of FIG. 22, the subcarrier band output signal is multiplied, in each branch, by a respective despreading coefficient

$${γ}_{k}^{*}$$

of a length—L despreading sequence to generate a set of despread chips. With reference to FIG. 20, the set of subcarrier band output signals is provided from the output of OFMT-SS analysis filter bank 2012 to an input 2030 of symbol despreader 2014. The subcarrier band output signals are processed by symbol despreader 2014 to generate the set of despread chips.

At an act 2222 of FIG. 22, the despread chips are combined using a maximum ratio combiner (MRC) to obtain symbol estimates of the data symbols. With reference to FIG. 20, decision logic 2018 performs symbol estimation using maximum ratio combining of the despread received chips to obtain symbol estimates s[n] of the transmitted data symbols.

At an act 2224 of FIG. 22, the symbol estimates s[n] are decoded to obtain a sequence of bits. With reference to FIG. 20, decision logic 2018 also performs symbol detection to determine the detected symbols, which are provided at an output 2034.

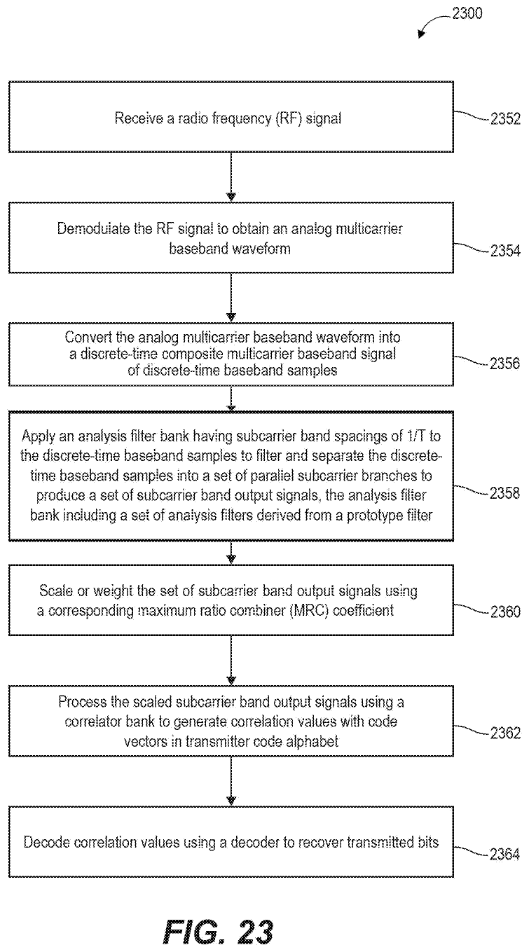

FIG. 23 is a flowchart of a method 2300 of OFMT-SS receiver processing with multi-code despreading, according to one or more examples. In one or more examples, method 2300 is performed using OFMT-SS receiver 2000 with multi-code despreading using symbol despreader 2014 of FIG. 21. In one or more examples, method 2300 and/or operation of OFMT-SS receiver 2000 of FIGS. 20 and 21 are based on the principles and techniques discussed and shown in relation to FIGS. 1A-1B and 2-13. In one or more examples, the receiver processing circuitry is implemented using at least one processor (e.g., a DSP) executing processor-executable instructions or dedicated digital hardware circuitry (e.g., an FPGA or ASIC), depending on system requirements. In method 2300 of FIG. 23, respective ones of acts 2352, 2354, 2356, and 2358 may be substantially the same as or similar to acts 2212, 2214, 2216, and 2218 of FIG. 22, but are repeated in the discussion for clarity and completeness.

At an act 2352 of FIG. 23, an RF signal is received. In this context, the RF signal is an RF OFMT-SS signal. At an act 2354 of FIG. 23, the received RF OFMT-SS signal is demodulated to obtain an analog multicarrier baseband waveform. At an act 2356 of FIG. 23, the analog multicarrier baseband waveform is converted, using an ADC, into a discrete-time composite multicarrier baseband signal. The discrete-time composite multicarrier baseband signal is comprised of discrete-time baseband samples. With reference to FIG. 20, RF demodulator 2204 receives the RF OFMT-SS signal at input 2002 and demodulates the signal to obtain the analog multicarrier baseband waveform. RF demodulator 2004 outputs the analog waveform to the ADC, which performs the conversion of the waveform into the discrete-time baseband samples.

At an act 2358 of FIG. 23, an analysis filter bank having subcarrier band spacings of 1/T is applied to the discrete-time baseband samples to filter and separate the discrete-time baseband samples into a set of parallel subcarrier branches to produce a set of subcarrier band output signals corresponding to respective subcarrier bands. The analysis filter band includes a set of analysis filters derived from a prototype filter (e.g., the common or transmitter prototype filter). With reference to FIG. 20, the discrete-time baseband samples (e.g., from the output of the ADC) are input to OFMT-SS analysis filter bank 2012. OFMT-SS analysis filter bank 2012 processes the discrete-time baseband samples to generate the set of subcarrier band output signals. More specifically, within OFMT-SS analysis filter bank 2012, the analysis filters derived from the prototype filter are used to filter and separate the discrete-time baseband samples into the set of parallel subcarrier branches. OFMT-SS analysis filter bank 2012 produces, at its output, the set of subcarrier band output signals corresponding to the respective subcarrier bands. With reference to FIGS. 20 and 21, the set of subcarrier band output signals is provided from the output of OFMT-SS analysis filter bank 2012 to an input 2030 of symbol despreader 2014.

At an act 2360 of FIG. 23, the set of subcarrier band output signals are scaled or weighted using respective maximum ratio combining (MRC) coefficients. At an act 2362 of FIG. 23, the scaled set of subcarrier band output signals is processed using a correlator bank to generate correlation values with code vectors in a code alphabet of the transmitter. At an act 2364 of FIG. 23, the correlation values are decoded using a decoder to recover the transmitted bits.

With reference to FIG. 21, the scaling of the set of subcarrier band output signals may be performed prior to processing by phase rotator 2102 of symbol despreader 2014. The scaling (or weighting) of the set of subcarrier band output signals using the respective MRC coefficients generates a scaled set of subcarrier band output signals. In symbol despreader 2014, phase rotator 2102 processes (e.g., phase-rotates) the scaled set of subcarrier band output signals to generate phase-corrected signals. Using FFT 2104, an FFT is performed on the phase-corrected signals to transform them into frequency domain signals. The frequency domain signals are processed by correlation multiplier 2106 (i.e., the correlator bank) to compute correlation values with code vectors in the code alphabet. Using IFFT 2108, an IFFT is performed on the correlation values to transform them into time domain signals to generate multi-code correlations at an output 2032. The multi-code correlations may correspond to despread chip correlation values. With reference to FIG. 20, decision logic 2018 may be used to decode the correlation values to recover the transmitted bits. In one or more particular examples, decision logic 2018 may be used to generate symbol estimates by selecting the codeword index with the largest correlation metric and mapping that selected codeword to the symbol estimate. Symbols may be detected by performing maximum-metric detection or other suitable technique.

At an act 2224 of FIG. 22, the symbol estimates s[n] are decoded to obtain a sequence of bits. With reference to FIG. 20, a decoder maps the detected symbols from decision logic 2018 to recover the transmitted bits.

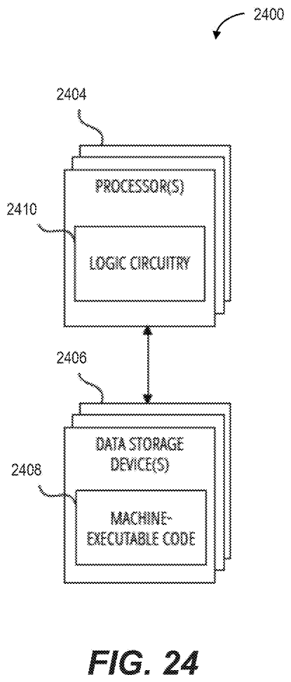

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 24 illustrates non-limiting examples of implementations of functional elements disclosed herein. In some examples, some or all portions of the functional elements disclosed herein may be performed by hardware specially implemented for carrying out the functional elements.

FIG. 24 is a block diagram of an example device 2400 that, in various embodiments, may be used to implement various functions, operations, acts, processes, and/or methods disclosed herein. Device 2400 includes one or more processors 2404 (sometimes referred to herein as “processors 2404”) operably coupled to one or more apparatuses such as data storage devices (sometimes referred to herein as “storage 2406”), without limitation. Storage 2404 includes machine-executable code 2408 stored thereon (e.g., stored on a computer-readable memory) and processors 2404 include logic circuitry 2410. Machine-executable code 2408 includes information describing functional elements that may be implemented by (e.g., performed by) logic circuitry 2410. Logic circuitry 2410 is adapted to implement (e.g., perform) the functional elements described by machine-executable code 2408. Device 2400, when executing the functional elements described by machine-executable code 2408, should be considered as special purpose hardware configured for carrying out the functional elements disclosed herein. In various embodiments, processors 2404 may be configured to perform the functional elements described by machine-executable code 2408 sequentially, concurrently (e.g., on one or more different hardware platforms), or in one or more parallel process streams.

When implemented by logic circuitry 2410 of processors 2404, machine-executable code 2408 is configured to adapt processors 2404 to perform operations of embodiments disclosed herein. For example, machine-executable code 2408 may be configured to adapt processors 2404 to perform at least a portion or a totality of the processes, operations, and/or methods described above in relation to FIGS. 1B and 2-23.

Processors 2404 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the disclosure. It is noted that a general-purpose processor (may also be referred to herein as a host processor or simply a host) may be a microprocessor, but in the alternative, processors 2404 may include any conventional processor, controller, microcontroller, or state machine. Processors 2404 may also be implemented as a combination of computing devices, such as a combination of a DSP and a microprocessor, a plurality of microprocessors, one or more microprocessors in conjunction with a DSP core, or any other such configuration.

In some embodiments, storage 2406 includes volatile data storage (e.g., random-access memory (RAM)), non-volatile data storage (e.g., Flash memory, a hard disc drive, a solid state drive, erasable programmable read-only memory (EPROM), without limitation). In some embodiments, processors 2404 and storage 2406 may be implemented into a single device (e.g., a semiconductor device product, a system on chip, without limitation). In some embodiments, processors 2404 and storage 2406 may be implemented into separate devices.

In some embodiments, machine-executable code 2408 may include computer-readable instructions (e.g., software code, firmware code). By way of non-limiting example, the computer-readable instructions may be stored by storage 2406, accessed directly by processors 2404, and executed by processors 2404 using at least logic circuitry 2410. Also by way of non-limiting example, the computer-readable instructions may be stored on storage 2406, transmitted to a memory device (not shown) for execution, and executed by processors 2404 using at least logic circuitry 2410. Accordingly, in some embodiments logic circuitry 2410 includes electrically configurable logic circuitry.

In some embodiments, machine-executable code 2408 may describe hardware (e.g., circuitry) to be implemented in logic circuitry 2410 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog, SystemVerilog, or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 2410 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, machine-executable code 2408 may include an HDL, an RTL, a GL description, a mask level description, other hardware description, or any combination thereof.

In some embodiments, where machine-executable code 2408 includes a hardware description (at any level of abstraction), a system (not shown, but including storage 2406) may be configured to implement the hardware description described by machine-executable code 2408. By way of non-limiting example, processors 2404 may include a programmable logic device (e.g., an FPGA or a PLC) and the logic circuitry 2410 may be electrically controlled to implement circuitry corresponding to the hardware description into logic circuitry 2410. Also by way of non-limiting example, logic circuitry 2410 may include hard-wired logic manufactured by a manufacturing system (not shown, but including storage 2406) according to the hardware description of machine-executable code 2408.

Regardless of whether machine-executable code 2408 includes computer-readable instructions or a hardware description, logic circuitry 2410 is adapted to perform the functional elements described by machine-executable code 2408 when implementing the functional elements of machine-executable code 2408. It is noted that although a hardware description may not directly describe functional elements, a hardware description indirectly describes functional elements that the hardware elements described by the hardware description are capable of performing.

While the disclosure is susceptible to various modifications and implementation in alternative forms, specific embodiments have been shown by way of examples in the drawings and have been described in detail herein. However, it should be understood that the invention is not intended to be limited to the particular forms disclosed. Rather, the invention includes all modifications, equivalents, and alternatives falling within the scope of the following appended claims and their legal equivalents.

What is claimed is:

1. A method of whitening spectrum of filtered multi-tone spread spectrum (FMT-SS), the method comprising:
generating overlapped FMT-SS (OFMT-SS) signals by inserting additional subcarriers in otherwise unused spectral nulls between adjacent subcarriers of FMT-SS.

2. The method of claim 1, further comprising:
determining constraints on the additional subcarriers to assure a spectrum of the OFMT-SS signals is substantially flat.

3. The method of claim 1, further comprising:
limiting spreading coefficients of a spreading vector used to spread data symbols across subcarriers of OFMT-SS to binary values of +1 and −1, with adjacent subcarriers of OFMT-SS exhibiting phase differences of π/2.

4. The method of claim 1, comprising:
employing spreading codes optimized using simulated annealing to reduce or minimize a peak-to-average power ratio (PAPR) of the OFMT-SS signals.

5. The method of claim 1, comprising:
employing spreading codes generated by circularly shifting a seed code to reduce or minimize the PAPR of the OFMT-SS signals.

6. The method of claim 1, further comprising:
applying a clipping method to reduce or minimize a peak-to-average power ratio (PAPR) of the OFMT-SS signals to an extent permitted by a processing gain of OFMT-SS.

7. An apparatus comprising:
a transmitter processing circuitry configured to:
map a sequence of bits to a sequence of data symbols with a time spacing of T;
replicate each data symbol across a set of parallel subcarrier branches;
multiply, in each parallel subcarrier branch, the data symbol by a respective spreading coefficient γₖ of a length—L spreading sequence to generate a set of spread symbol chips;
apply a synthesis filter bank having subcarrier band spacings of
$$\frac{1}{T}$$
to the set of spread symbol chips to generate filtered subcarrier signals and combine the filtered subcarrier signals to generate a discrete-time composite multicarrier baseband waveform; and
convert discrete-time baseband samples of the discrete-time composite multicarrier baseband waveform into an analog multicarrier baseband waveform.

8. The apparatus of claim 7, wherein:
the discrete-time composite multicarrier baseband waveform comprises a discrete-time overlapped filtered multi-tone (OFMT) spread-spectrum (SS) (OFMT-SS) baseband waveform; and
the analog multicarrier baseband waveform comprises an analog OFMT-SS baseband waveform.

9. The apparatus of claim 8, wherein:
the transmitter processing circuitry is configured to:
modulate the analog OFMT-SS baseband waveform onto a radio frequency (RF) carrier to generate an RF signal; and
transmit the RF signal via an antenna, the transmitted RF signal comprising a transmitted RF OFMT-SS signal.

10. The apparatus of claim 7, wherein:
the transmitter processing circuitry is configured to:
perform single-code spreading by applying a same spreading code to each data symbol, the same spreading code comprising a length—L sequence that defines the respective spreading coefficients γₖ.

11. The apparatus of claim 7, wherein:
the transmitter processing circuitry is configured to:
perform multi-code spreading by selecting, for each data symbol, a spreading code from a set of spreading codes, each spreading code comprising a length—L sequence that defines respective spreading coefficients γₖ.

12. The apparatus of claim 7, wherein:
the transmitter processing circuitry is configured to:
apply a clipping algorithm to the discrete-time baseband samples to generate peak-limited discrete-time baseband samples, to thereby reduce a peak-to-average power ratio (PAPR) of the discrete-time composite multicarrier baseband waveform.

13. The apparatus of claim 7, wherein the transmitter processing circuitry is implemented using at least one processor executing processor-executable instructions or dedicated digital hardware circuitry.

14. An apparatus comprising:
a receiver processing circuitry configured to:
convert an analog multicarrier baseband waveform into a discrete-time composite multicarrier baseband waveform comprising discrete-time baseband samples;
apply an analysis filter bank having subcarrier band spacings of
$$\frac{1}{T}$$
to the discrete-time baseband samples to filter and separate the discrete-time baseband samples into a set of parallel subcarrier branches to produce a set of subcarrier band output signals corresponding to respective subcarrier bands, the analysis filter bank comprising a set of analysis filters derived from a prototype filter;
multiply, in each parallel subcarrier branch, the subcarrier band output signal by a respective despreading coefficient
$${γ}_{k}^{*}$$
of a length—L despreading sequence to generate a set of despread chips;
combine the despread chips across the parallel subcarrier branches to obtain symbol estimates of data symbols; and
decode the symbol estimates to obtain a sequence of bits.

15. The apparatus of claim 14, wherein:
the analog multicarrier baseband waveform comprises an analog overlapped filtered multi-tone (OFMT) spread-spectrum (SS) (OFMT-SS) baseband waveform, and
the discrete-time composite multicarrier baseband waveform comprises a discrete-time OFMT-SS baseband waveform.

16. The apparatus of claim 15, wherein:
the receiver processing circuitry is configured to:
receive a radio frequency (RF) signal via an antenna, the received RF signal comprising a received RF OFMT-SS signal; and
demodulate the received RF OFMT-SS signal to obtain the analog OFMT-SS baseband waveform.

17. The apparatus of claim 14, wherein:
the receiver processing circuitry is configured to combine the despread chips using a maximum ratio combiner (MRC) to obtain the symbol estimates.

18. The apparatus of claim 14, wherein:
the receiver processing circuitry is configured to perform single-code despreading by applying the same length—L despreading sequence to each data symbol.

19. The apparatus of claim 14, wherein:
the receiver processing circuitry is configured to perform multi-code despreading by selecting, for each data symbol, a despreading sequence from a set of length—L despreading sequences, each despreading sequence defining respective despreading coefficients
$${γ}_{k}^{*} .$$

20. The apparatus of claim 19, wherein:
the receiver processing circuitry configured to, for the multi-code despeading:
scale the set of subcarrier band output signals with respective maximum ratio combining (MRC) coefficients to generate a scaled set of subcarrier band output signals;
phase-rotate the scaled set of subcarrier band output signals to generate phase-corrected signals;
perform a Fast Fourier Transform (FFT) on the phase-corrected signals to generate frequency-domain signals;
process the frequency-domain signals using a correlation multiplier to compute correlation values; and
perform an Inverse FFT (IFFT) on the correlation values to generate multi-code correlations.
